(19) United States
(12) Patent Application Publication
(10) Pub. No.: US 2025/0112316 A1
(43) Pub. Date: Apr. 3, 2025

(54) CELL-TO-PACK BATTERY PACK APPARATUS AND METHODS

(71) Applicant: Cummins Inc., Columbus, IN (US)

(72) Inventors: John Ringstad, Oregon, WI (US); Leonardo Hoss, Columbus, IN (US); Ryan Green, Columbus, IN (US); Erik L. Piper, Columbus, IN (US); Fouad Sherif Issa, Columbus, IN (US)

(21) Appl. No.: 18/905,863

(22) Filed: Oct. 3, 2024

Related U.S. Application Data
(60) Provisional application No. 63/542,282, filed on Oct. 3, 2023.

(51) Int. Cl. H01M 50/258; H01M 10/613; H01M 10/625; H01M 10/6557; H01M 50/249; H01M 50/367

(52) U.S. Cl. CPC H01M 50/258; H01M 10/613; H01M 10/625; H01M 10/6557; H01M 50/249; H01M 50/367

(57) ABSTRACT

In implementations, a high-voltage power system may include circuitry and a cell-to-pack battery that is operatively connected to the circuitry. The cell-to-pack battery has: a cell arrangement including one or more cells, the cell arrangement configured to store energy for conversion into electrical energy for use in the high-voltage power system; a thermal management system having at least one of a first cooling plate arranged at a first side of the cell arrangement and a second cooling plate is arranged at a second side of the cell arrangement; and a modular open frame with which to secure the cell arrangement and the thermal management system, the modular open frame including a manifold for vent gas collection and an electrical box that houses a majority of electrical components for the battery pack, each of the manifold and the electrical box being connectible to the cell arrangement.

### CROSS-REFERENCE TO RELATED APPLICATIONS

The present application claims priority to U.S. Provisional Patent Application 63/542,282, filed on Oct. 3, 2023, the entire contents of which are hereby incorporated by reference in their entirety.

### TECHNICAL FIELD

The present invention relates to techniques for servicing battery modules and battery packs. The invention has particular, but not exclusive, application to battery cells for use in battery packs for use in traction applications, such as electric or hybrid electric vehicles, construction equipment and the like.

### BACKGROUND

Electric and hybrid electric vehicles, such as automobiles, buses, vans and trucks, use battery packs designed to have a high amp-hour capacity to provide power for sustained periods of time. A battery pack includes a large number of individual electrochemical cells connected in series and parallel to achieve overall voltage and current requirements. Typically, lithium ion (li-ion) battery cells are used because they provide relatively good cycle life and energy density.

### SUMMARY

Battery packs disclosed herein may include a cell arrangement including one or more cells, the cell arrangement configured to store energy for conversion into electrical energy for use in the energy storage system, the cell arrangement including at least one tier of cells to form a stack. Battery pack may include a thermal management system having a plurality of cooling plates that includes first and second cooling plates, the first and second cooling plates sandwich the one or more cells in the cell arrangement such that a first cooling plate is arranged at a first side of the cell arrangement and a second cooling plate is arranged at a second side of the cell arrangement. Battery pack may include an open frame with which to secure the cell arrangement and the thermal management system. The open frame includes first and second endplates flanking the cell arrangement, the first endplate being integrated into a manifold for vent gas collection at least in a direction from the second endplate to the first endplate, the second endplate being integrated into an electrical box that houses a majority of electrical components for the battery pack. The electrical box includes circuitry for placing the cells in electronic communication with a battery pack controller.

Advantages and features of the embodiments of this disclosure will become more apparent from the following detailed description of exemplary embodiments when viewed in conjunction with the accompanying drawings

### BRIEF DESCRIPTION OF THE DRAWINGS

FIG. 1 is a schematic of an electrified vehicle;

FIG. 2A is a perspective view of a battery pack;

FIG. 2B is an exploded view of the battery pack in FIG. 2A.

FIG. 3 is a perspective view of a first configuration of a battery pack;

FIG. 4 is a perspective view of a second configuration of a battery pack;

FIG. 5 is a perspective view of a third configuration of a battery pack;

FIG. 6 is a perspective view of a fourth configuration of a battery pack;

FIG. 7 is a diagram showing how increasing the number of cells can increase the length of a tier of battery pack;

FIG. 8 is a cross section of a battery pack showing an example arrangement of cooling plates between tiers of the battery pack;

FIG. 9 is a diagram of an example thermal gradient through the thickness of a cell;

FIG. 10 is a contour plot illustrating a cooling profile across a tier;

FIG. 11 is a partial perspective view of an endplate that flanks a the middle section and attaches an electrical box to a battery pack;

FIG. 12 is a close-up view of the endplate in FIG. 11 at an interface with which the electrical box is place in communication with cells of a tier;

FIG. 13 shows an exploded view of a the electrical box before mating with the middle section;

FIG. 14 is a diagram showing a vent gas path through the battery pack and exhaust via a manifold attached to the middle section;

FIG. 15 is an exploded view of portions of the vent gas collection before attachment to the middle section;

FIG. 16 is a partial perspective view of an endplate with vents stemming from vertical channels in an integrated coolant distribution manifold formed at an endplate

FIG. 17 is a vertical cross section of the integrated coolant distribution manifold to show innards of the vertical cooling channels;

FIG. 18 is a partial perspective view of an endplate having vertically oriented cooling channels that are formed into the endplate with cooling holes at each tier;

FIG. 19 is a partial perspective view of an endplate having orifice plates that can modify flow through the cooling channels when assembled;

FIG. 20 is a partial perspective view of an endplate having orifice plates positioned at cooling passages formed between the cooling channels in the endplate and the manifold;

FIG. 21 is a side schematic view of the cooling passages and orifices;

FIG. 22 is a back view of the schematic shown in FIG. 21;

FIG. 23 is a diagram of a process by which numerous cells are adhered with alternating polarity for forming a tier of the battery pack;

FIG. 24 is a diagram of a setup for a ram fixture to compress and hold endplates to a set distance;

FIG. 25 is a diagram of a step of welding busbars to tabs of the cells while compression is held and/or the cells being laminated as an assembly;

FIG. 26 is a diagram of a step at which supports are connected to the cells and, optionally, have those structures be tie rods to allow compression to be released before welding;

FIG. 27 is a diagram of a step at which side rails are attached) at which point the compression can be release;

FIG. 28 is a diagram of a step at which a bottom of the cell stack is aligned on thermal interface material (“TIM”) on a cooling plate, aided by locating features;

FIG. 29 is a diagram of a step at which tiers can be stacked if desires by adding TIM and/or sealant to a top surface of the cell stack followed by a cooling plate;

FIG. 30 is a diagram of a step at which the tiers are secured via bolts and/or welding;

FIG. 31 is a diagram of a step at which the E-Box and vent collectors are added to flank a middle section of the battery pack, each according to principles of the present disclosure;

FIG. 32 is a perspective view of a stack of welded tiers;

FIG. 33 is an exploded view of the stack in FIG. 33;

FIG. 34 is a perspective view showing a bottom of a welded tier; and

FIG. 35 is a perspective view showing a top of the welded tier in FIG. 34.

### DETAILED DESCRIPTION

For the purposes of promoting an understanding of the principles of the present disclosure, reference is now made to the embodiments illustrated in the drawings, which are described below. The exemplary embodiments disclosed herein are not intended to be exhaustive or to limit the disclosure to the precise form disclosed in the following detailed description. Rather, these exemplary embodiments were chosen and described so that others skilled in the art may utilize their teachings. It is not beyond the scope of this disclosure to have a number (e.g., all) the features in a given embodiment to be used across all embodiments.

As backdrop, described herein are devices, systems, and method related to the use of energy storage systems (“ESS”), such both mobile and stationary ESSes. A mobile ESS includes a group of devices (e.g., battery cells and/or battery modules) assembled together that is capable of storing energy for later supplying electrical energy. A mobile ESS is capable of being moved (e.g., in on- and/or off-highway applications) and typically used as a temporary source of electrical power. Often arranged in a battery storage array, mobile ESSes vary in size from handheld to about the size of a semi-trailer with the most prevalent type being lithium-ion battery energy storage systems. Typical use cases for mobile ESSes are to provide emergency backup power, supplementing electric vehicle charging stations (e.g., during high demand), or any other application where electrical power is needed.

Stationary ESSes are designed to store energy and release it at a later point in time as electrical energy (e.g., to power equipment, including mobile ESSes). In most cases, a stationary ESS will include an array of batteries (including “second use” batteries mobile ESSes), an electronic control system, inverter, and thermal management system 228 within an enclosure. Stationary ESSes are often deployed in utility scale energy storage systems (e.g., by utilities, power producers, and grid operators) to address a range of customer challenges including intermittent renewables, peak demand and short outages, and enhancement of power grid stability. Other uses of stationary ESSes include commercial building applications where energy costs are significant and/or the continuity of operations is extremely critical as well as applications where uninterrupted power supply is desired in the event of an outage, while backup power generators are starting up (e.g., to supplement loads that have significant voltage and frequency fluctuation).

Notably, devices, systems, and methods disclosed herein include a high-performance, low-cost battery pack for use in a variety of ESS applications. Principles of the present disclosure include a cell-to-pack battery pack. In examples, such battery packs use an open frame 230 enclosure combined with a high-performance thermal management system 228 (“TMS”) to optimally dissipate and/or preheat the battery, a separate electrical box, an integrated cooling manifold, and enhanced thermal propagation management. The result is a battery pack with reduced overall design and manufacturing complexity that is robust, high performance, extended life, and cost competitive. The battery pack can also having space and weight efficiency.

According to principles of the present disclosure, battery packs provide several advantages over pre-existing solutions. For instance, example battery packs applications have improved design and manufacturing aspect as compared to pre-existing solutions that use a closed frame enclosure, creating additional manufacturing steps and complexity (e.g., intermediate steps for cell-to-module and module-to-pack considerations) thereby increasing the overall cost. Second, example battery packs applications have improved design and high-performance TMS as compared to pre-existing solutions that use side cooling or face cooling, each of which drives a much more complex design and lower robustness due to multiple cooling connections inside the pack. Third, example battery packs applications have an electrical electronics box that is separate from the cell section. In contrast, pre-existing solutions have electrical and BMS components inside the cell section, which drives additional integration complexity with reduced serviceability. Last, example battery packs applications have an integrated cooling manifold with orifice flow management. In contrast, pre-existing solutions have separate cooling manifolds, which require additional components and packaging space that add additional weight and cost. Principles of the present disclosure include the following implementations: using a closed frame enclosure, using a more complex cooling system (for example face cooling, side cooling or immersive cooling), having the electrical and BMS components inside the pack, having the cooling manifolds not integrated.

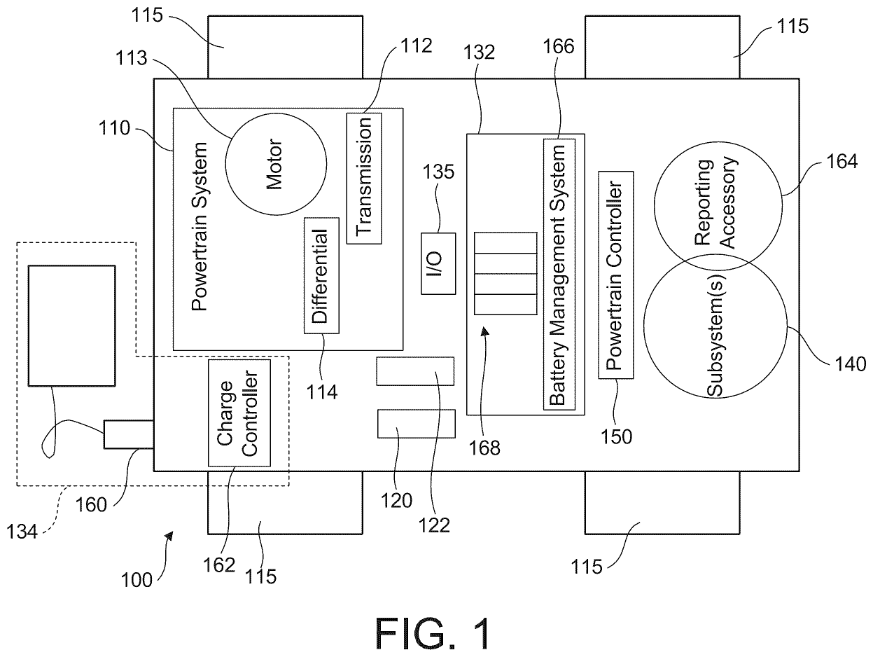

Now referring initially to FIG. 1, a schematic diagram of a battery electric vehicle 100 is provided. While the vehicle is referred to as a battery electric vehicle, it is understood that the vehicle may include a hybrid vehicle, such as a plug-in hybrid vehicle, powered or otherwise operable via a battery and, optionally, one or more of a generator (e.g., a power generator, generator plant, electric power strip, on-board rechargeable electricity storage system, etc.) and a motor (e.g., an electric motor, traction motor, etc.). Battery electric vehicle 100 may be operable in at least one of a reverse direction (e.g., a backward direction relative to a front end of battery electric vehicle 100) and a non-reverse direction (e.g., a forward direction, angular direction, etc., relative to the front end of battery electric vehicle 100). Battery electric vehicle 100 may be an on-road or off-road vehicle including, but not limited to, cars, trucks, ships, boats, vans, airplanes, spacecraft, or any other type of vehicle.

Battery electric vehicle 100 comprises a powertrain controller 150 communicably and operatively coupled to a powertrain system 110, a brake mechanism 120, an accelerator pedal 122, one or more sensors, an operator input/output (I/O) device 135, and one or more additional vehicle subsystems 140. Battery electric vehicle 100 may include additional, fewer, and/or different components systems than depicted in FIG. 1, such that the principles, methods, systems, apparatuses, processes, and the like of the present disclosure are intended to be applicable with any suitable vehicle configuration. It should also be understood that the principles of the present disclosure should not be interpreted to be limited to on-highway vehicles; rather, the present disclosure contemplates that the principles may also be applied to a variety of other applications including, but not limited to, off-highway construction equipment, mining equipment, marine equipment, locomotive equipment, etc.

Powertrain system 110 facilitates power transfer from a battery 132 and/or a motor 113 to power battery electric vehicle 100. In an exemplary embodiment, powertrain system 110 includes motor 113 operably coupled to battery 132 and charge system 134, where motor 113 transfers power to a final drive (e.g., wheels 115) to propel battery electric vehicle 100. As depicted, powertrain system 110 may include other various components, such as a transmission 112 and/or differential 114, where differential 114 transfers power output from transmission 112 to final drive 115 to propel battery electric vehicle 100. Powertrain controller 150 of battery electric vehicle 100 provides electricity to motor 113 (e.g., an electric motor) in response to various inputs received by powertrain controller 150, for example, from accelerator pedal 122, sensors, vehicle subsystems 140, charge system 134 (e.g., a battery charging system, rechargeable battery, etc.). In some embodiments, electricity provided to power motor 113 may be provided by an onboard gasoline-engine generator, a hydrogen fuel cell, etc.

In some embodiments, battery electric vehicle 100 may include transmission 112. Transmission 112 may be structured as any type of transmission compatible with battery electric vehicle 100, including a continuous variable transmission, a manual transmission, an automatic transmission, an automatic-manual transmission, or a dual clutch transmission, for example. Accordingly, as transmissions vary from geared to continuous configurations, transmission 112 may include a variety of settings (e.g., gears, for a geared transmission) that affect different output speeds based on an engine speed or motor speed. Like transmission 112, motor 113, differential 114, and final drive 115 may be structured in any configuration compatible with battery electric vehicle 100. In some embodiments, transmission 112, is omitted and motor 113 is directly coupled to differential 114. In other embodiments, motor 113 is directly coupled to final drive 115 as a direct drive application. In some examples, battery electric vehicle may comprise multiple instances of motor 113, for example, one instance for each driven wheel, one instance per driven axle, or other compatible arrangements.

Brake mechanism 120 may be implemented as a brake (e.g., hydraulic disc brake, drum brake, air brake, etc.), braking system, or any other device configured to prevent or reduce motion by slowing or stopping components (e.g., a wheel, axle, pedal, crankshaft, driveshaft, etc. of battery electric vehicle 100). Generally, brake mechanism 120 is configured to receive an indication of a desired change in the vehicle speed. In some embodiments, brake mechanism 120 comprises a brake pedal operable between a released state and an applied state by an operator of battery electric vehicle 100. The brake pedal may be configured as a pressure-based system responsive to applied pressure or a travel-based system responsive to a travel distance of the pedal, where a force applied to brake mechanism 120 is proportional to the pressure and/or travel distance. In some embodiments, all or a portion of brake mechanism 120 is incorporated into motor 113, for example, as a regenerative brake mechanism.

Generally, the released state of brake mechanism 120 corresponds to a brake pedal in a default location where the brake mechanism is not applied, for example, when the operator's foot is not placed on the brake pedal at all, or merely resting on the brake pedal such that a minimum actuation force is not exceeded (e.g., a spring-assisted, hydraulic-assisted, or servo-assisted force that pushes the brake pedal to the default location). In some embodiments, the brake pedal is combined with accelerator pedal 122 in a one-pedal driving configuration. In some examples, the applied state of brake mechanism 120 may correspond to the brake pedal being pressed with a force that meets or exceeds the minimum actuation force. In other examples, the applied state of brake mechanism 120 corresponds to the brake pedal being pressed so that the travel distance of the brake pedal meets or exceeds a minimum travel distance. Generally, the minimum actuation force and/or minimum travel distance help to prevent accidental actuation of brake mechanism 120. Different levels of the minimum actuation force and/or minimum travel distance may be used for different implementations of brake mechanism 120, for example, relatively higher forces or travel distance for a foot-actuated brake pedal, relatively lower forces or travel distance for a hand-actuated brake lever. Although the brake pedal may have a range of pressures and/or travel distances that provide at least some braking effect on battery electric vehicle 100 (e.g., high pressures for hard or emergency braking, low pressures for gradual braking or “feathering” the brakes), this range of pressures and/or travel distances are within the applied state.

The released state may correspond to an indication of a desired increase in vehicle speed, while the applied state may correspond to an indication of a desired reduction in vehicle speed. In some embodiments, a reduction in actuation force and/or travel distance corresponds to a desired increase in vehicle speed, while an increase in actuation force and/or travel distance corresponds to a desired reduction in vehicle speed.

Accelerator pedal 122 may be structured as any type of torque and/or speed request device included with a system (e.g., a floor-based pedal, an acceleration lever, paddle or joystick, etc.). Sensors associated with accelerator pedal 122 and/or brake mechanism 120 may include a vehicle speed sensor that provides a vehicle speed signal corresponding to a vehicle speed of battery electric vehicle 100, an accelerator pedal position sensor that acquires data indicative of a depression amount of the pedal (e.g., a potentiometer), a brake mechanism sensor that acquires data indicative of a depression amount (pressure or travel) of brake mechanism 120, a coolant temperature sensor, a pressure sensor, an ambient air temperature, or other suitable sensors.

Battery electric vehicle 100 may include operator I/O device 135. Operator I/O device 135 may enable an operator of the vehicle to communicate with battery electric vehicle 100 and/or powertrain controller 150. Analogously, operator I/O device 135 enables battery electric vehicle 100 and/or powertrain controller 150 to communicate with the operator. For example, operator I/O device 135 may include, but is not limited to, an interactive display (e.g., a touchscreen) having one or more buttons, input devices, haptic feedback devices, an accelerator pedal, a brake pedal, a shifter or other interface for transmission 112, a cruise control input setting, a navigation input setting, or other settings or adjustments available to the operator. Via operator I/O device 135, powertrain controller 150 can also provide commands, instructions, and/or information to the operator or a passenger.

Battery electric vehicle 100 includes one or more vehicle subsystems 140, which may generally include one or more sensors (e.g., a speed sensor, ambient pressure sensor, temperature sensor, etc.), as well as any other subsystem that may be included with a vehicle. Vehicle subsystems 140 may also include torque sensors for one or more of motor 113, transmission 112, differential 114, and/or final drive 115. Other vehicle subsystems 140 may include a steering subsystem for managing steering functions, such as electrical power steering, and output information such as wheel position and fault codes corresponding to steering battery electric vehicle 100; an electrical subsystem which may include audio and visual indicators, such as hazard lights and speakers configured to emit audible warnings, as well as other functions; and a thermal management system 228, which may include components such as a radiator, coolant, pumps, fans, heat exchangers, computing devices, and associated software applications. Battery electric vehicle 100 may include further sensors other than those otherwise discussed herein, such as cameras, LIDAR, and/or RADAR, temperature sensors, smoke detectors, virtual sensors, among other potential sensors.

Powertrain controller 150 may be communicably and operatively coupled to powertrain system 110, brake mechanism 120, accelerator pedal 122, operator I/O device 135, and one or more vehicle subsystems 140. Communication between and among the components may be via any number of wired or wireless connections. For example, a wired connection may include a serial cable, a fiber optic cable, an SAE J1939 bus, a CAT5 cable, or any other form of wired connection. In comparison, a wireless connection may include the Internet, Wi-Fi, Bluetooth, Zigbee, cellular, radio, etc. In one embodiment, a controller area network (CAN) bus including any number of wired and wireless connections provides the exchange of signals, information and/or data. Powertrain controller 150 is structured to receive data (e.g., instructions, commands, signals, values, etc.) from one or more of the components of battery electric vehicle 100 as described herein via the communicable coupling of powertrain controller 150 to the systems and components of battery electric vehicle 100. In some embodiments, an additional or alternative controller may be used for receiving data from certain systems or components.

In vehicles including charge system 134, such as a plug-in charging system, battery electric vehicle 100 may powertrain controller 150 may control charging of battery 132 when a charger 160 of charge system 134 is connected to battery electric vehicle 100. A charge controller 162 establishes communications between powertrain controller 150 and charger 160. Charge controller 162 may receive a charge command from powertrain controller 150 and charger 160. Charge controller 162 may monitor sensor signals and perform safety and performance checks and determine faults based thereon. For example, charge controller 162 may determine a fault if charging has started but a physical connection between charger 160 and battery electric vehicle 100 fails to be detected or is detected to be outside safe boundaries. In other words, charge controller 162 may function as a communication interface between charger 160 and powertrain controller 150.

Powertrain controller 150 may be communicably coupled with charger 160, battery 132 and a reporting accessory 164 so that digital data may be transferred between components. Reporting accessory 164 may be include a vehicle subsystem 140 or another vehicle component. A CAN bus may be implemented to provide communications. In some embodiments, a first CAN bus may be implemented to provide communications between a first plurality of components while a second CAN bus may be implemented to provide communications between a second plurality of components. Any series or parallel communication scheme and protocol known in the arm may be implemented to provide communication.

Reporting accessory 164 may be operable to communicate information to powertrain controller 150. Such information may include identification, current demand, high or low voltage power draw, and other information required for operation of battery electric vehicle 100. Identification information may include a maximum current capacity of reporting accessory 164, for example. The current demand may be dynamic, such that the current demanded by reporting accessory 164 varies. Reporting accessory 164 may include an air-conditioning system, for example, and the current demand may vary based on a measured actual temperature of an interior of battery electric battery 100 compared to a target temperature. By reporting current demand to powertrain controller 150, reporting accessory 164 enables powertrain controller 150 to more accurately determine the target current to generate the charge command to charger 162. Comparatively, when the load of a non-reporting accessory is dynamic and unknown, charger 162 may underdeliver current to battery 132, extending charging time. The charge command may also take into account the charger's capability to deliver current and indicates to charger 162 the level of current to output to battery electric vehicle 100, which is ideally sufficient to optimally charge battery 132 and also power the accessories.

Battery 132 may include one or more battery packs including a battery management system 166 and battery modules 168. FIG. 1 is not determinative of the number of battery modules within a battery pack or the number of battery packs within battery 132. Battery 132 may include a greater number of battery packs and/or a greater or lesser number of battery modules. Temperature, voltage, and other sensors may be provided to enable battery management system 166 to manage the charging and discharging of battery modules 168 without exceeding their limits, to detect and manage faults, and to perform other known functions. Battery management system 166 may transmit data to powertrain controller 150 related to information about battery 132, including the battery charge power limit, temperature, faults, etc. Battery 132 may include a current sensor to provide a measured current value to battery management system 166, which may be used to affect the charge command provided to charger 162. The current sensor may be located elsewhere. Multiple current sensors may be used, each current sensor associated with a battery module of battery 132, where the sum of the measured currents being the measured current of battery 132.

Powertrain controller 150 may include a charge logic operable to determine a command for charger 162 to supply a target current to battery 132. The charge logic may also be integrated with a controller of battery management system 166 or provided in a standalone controller communicatively coupled to powertrain controller 150. The term “logic” as used herein includes software and/or firmware comprising processing instructions executing on one or more programmable processors, application-specific integrated circuits, field-programmable gate arrays, digital signal processors, hardwired logic, or combinations thereof, which may be referred to as “controllers.” Therefore, in accordance with the disclosure, various logic may be implemented in any appropriate fashion. A non-transitory machine-readable medium comprising logic can additionally be included within any tangible form of a computer-readable carrier, such as a solid-state memory, containing an appropriate set of computer instructions and data structures that would cause a processor to carry out the techniques described herein. A non-transitory computer-readable medium, or memory, may include random access memory (RAM), read-only memory (ROM), erasable programmable read-only memory (e.g., EPROM, EEPROM, or Flash), or any tangible medium capable of storing information.

A transport control system and charging system may communicatively connect multiple chargers and control charging processes in a depot, linking charging points, power supplies, and operational information systems, such as planning and scheduling systems. The transport control system may provide the charging management system information such as estimated arrival time of vehicles, time available for charging, and scheduled pull-out time. The charging management system can then calculate the charging requirements for each vehicle and optimize charging processes for the fleet of vehicles to, for example, avoid expensive grid peak load periods where possible. The charging management system may also assign time slots for charging to each vehicle and monitor the progress of charging of each vehicle. The charging management system may receive from each vehicle an estimated time to full charge. In other embodiments, the vehicle may provide the relevant data to the charging management system, which may then estimate the time to full charge within its control logic.

Although FIG. 1 is described as illustrating a battery electric vehicle, the disclosure provided herein may also apply to vehicles having other powertrains, such as, for example, a plug-in hybrid vehicle. In such embodiments, the vehicle optionally includes an engine which may be structured as an internal combustion engine that receives a chemical energy input (e.g., a fuel such as natural gas, gasoline, ethanol, or diesel) from a fuel delivery system, and combusts the fuel to generate mechanical energy, in the form of a rotating crankshaft. In such an embodiment, transmission receives the rotating crankshaft and manipulates the speed of the crankshaft (e.g., the engine speed, which is usually expressed in revolutions-per-minute (RPM)) to affect a desired draft shaft speed. A rotating drive shaft may be received by differential, which provides the rotation energy from the drive shaft to final drive, which then propels or moves the vehicle.

Further toward principles of the present disclosure, the battery pack 132 can advantageously be a cell-to-pack design. For instance, the battery pack 132 can include a plurality of battery cells (not shown). A casing (e.g., shown generally at 132) of the battery pack 132 can facilitate arranging the plurality of battery cells 201 into the battery pack 132. As discussed in further detail below, a cell-to-pack construction can provide numerous benefits to the electrified vehicle 100.

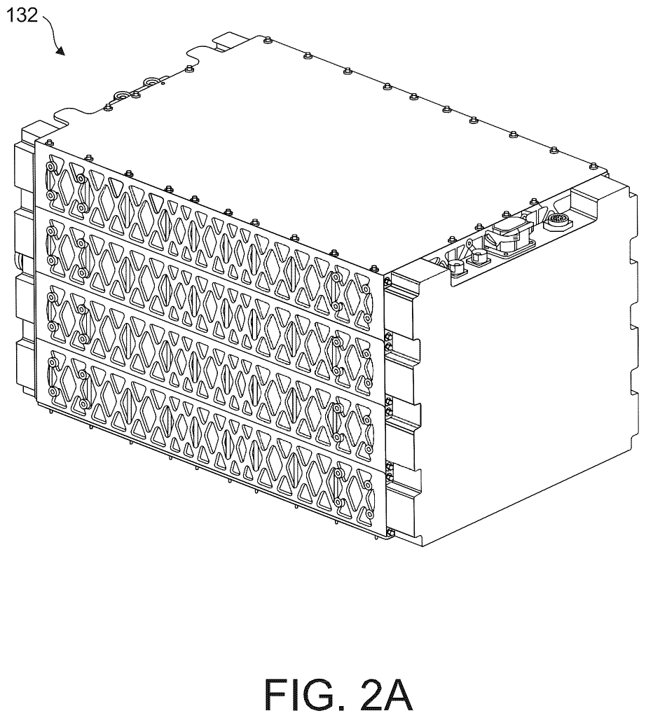

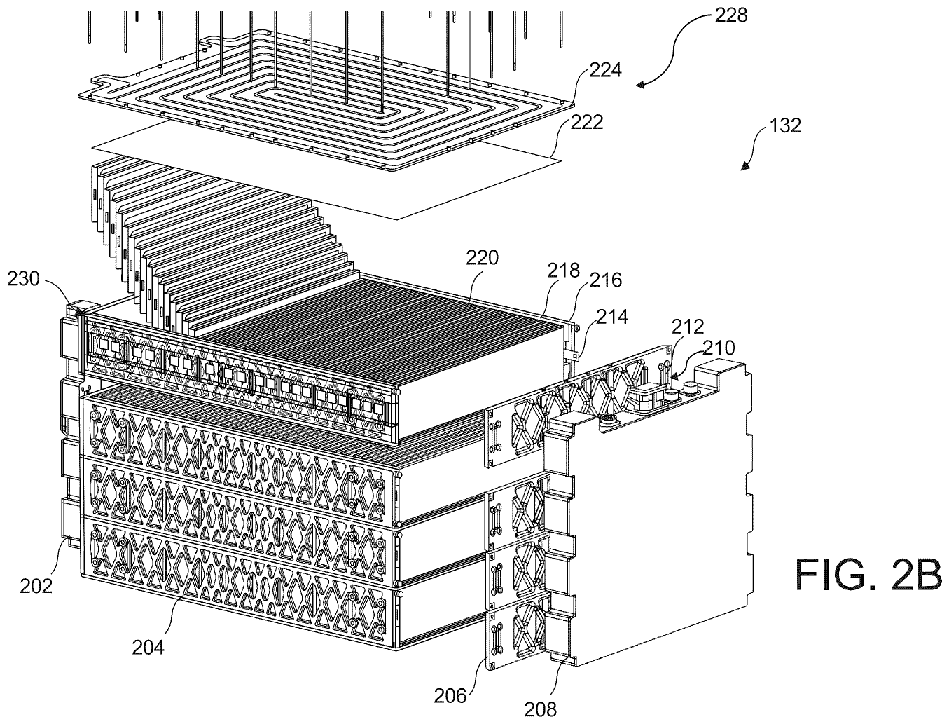

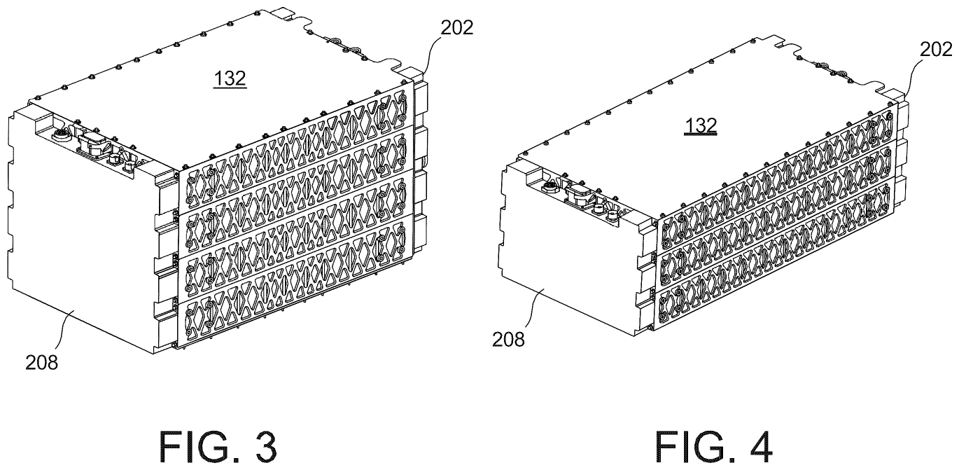

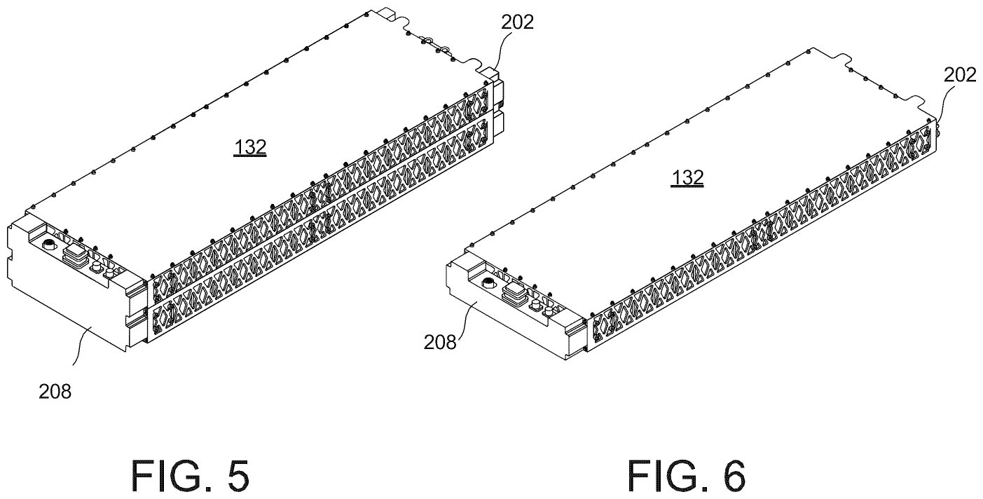

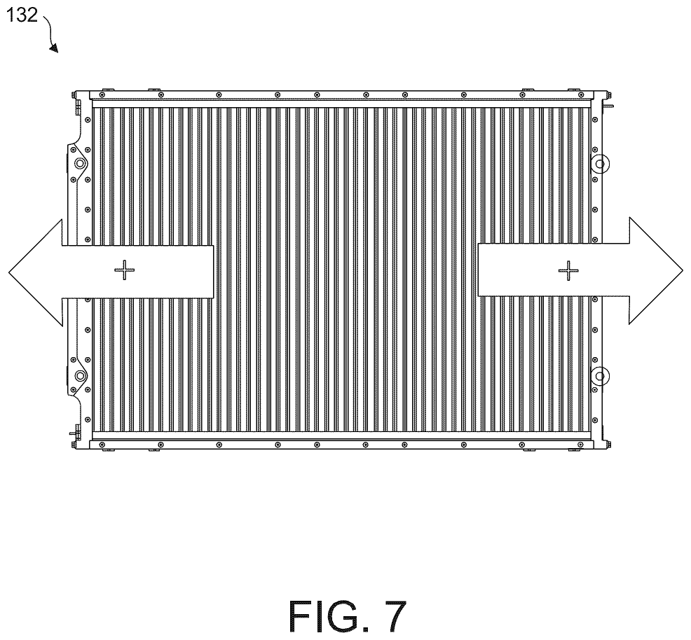

Various examples of battery packs 132 disclosed herein are shown in FIGS. 2-22. FIGS. 2A and 2B show an example battery pack according to principles of the present disclosure. In particular, FIG. 2A is a perspective view of a battery pack 132. FIG. 2B is an exploded view of the battery pack in FIG. 2A. FIGS. 3-6 show various configurations for the battery pack where, notably, the battery packs in FIGS. 3-5 have the same capacity with different tiers while the battery pack in FIG. 6 has a slim profile with a single tier. FIG. 7 is a diagram showing how increasing the number of cells 220 can increase the length of a tier.

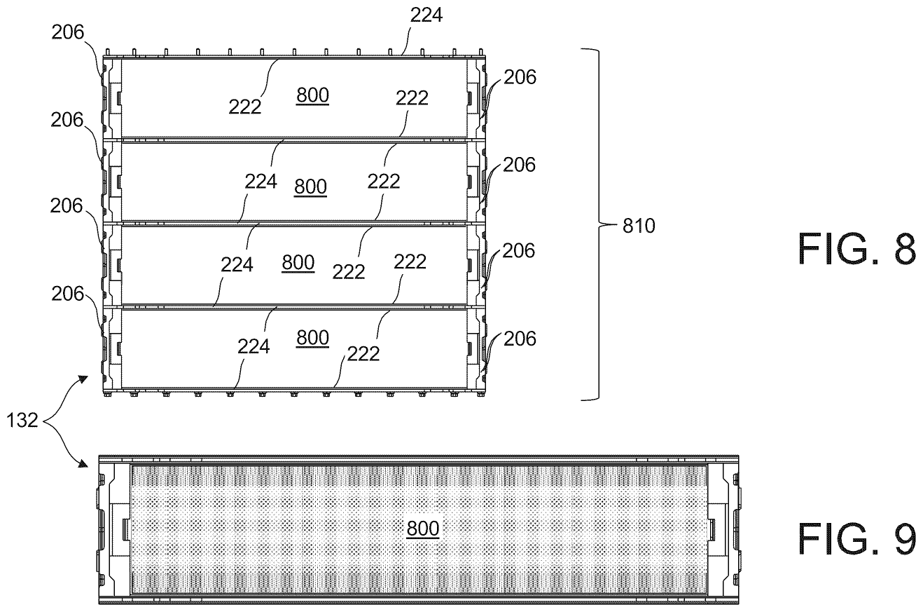

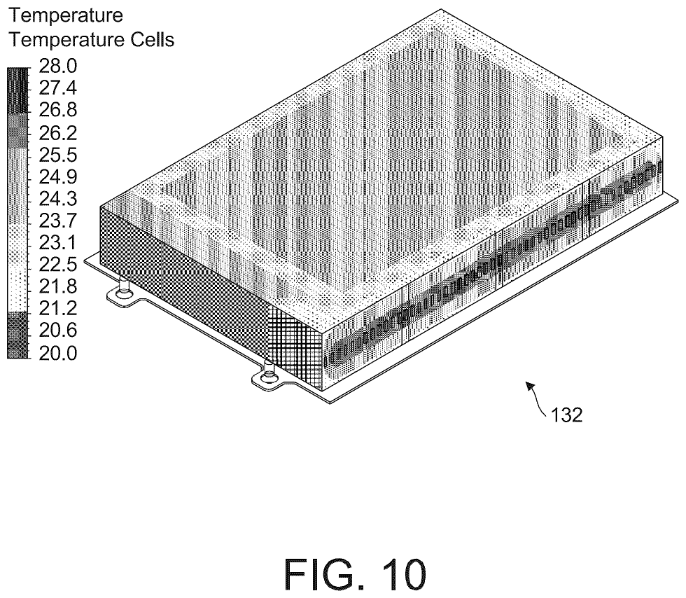

FIG. 8-10 show various aspects of a thermal management systems of the battery pack in a middle section (or cell section) of the battery pack. In particular, FIG. 8 shows an example arrangement of cooling plates 224 between tiers of the battery pack. FIG. 9 shows an example thermal gradient through the thickness of a cell. FIG. 10 is a contour plot illustrating a cooling profile across a tier.

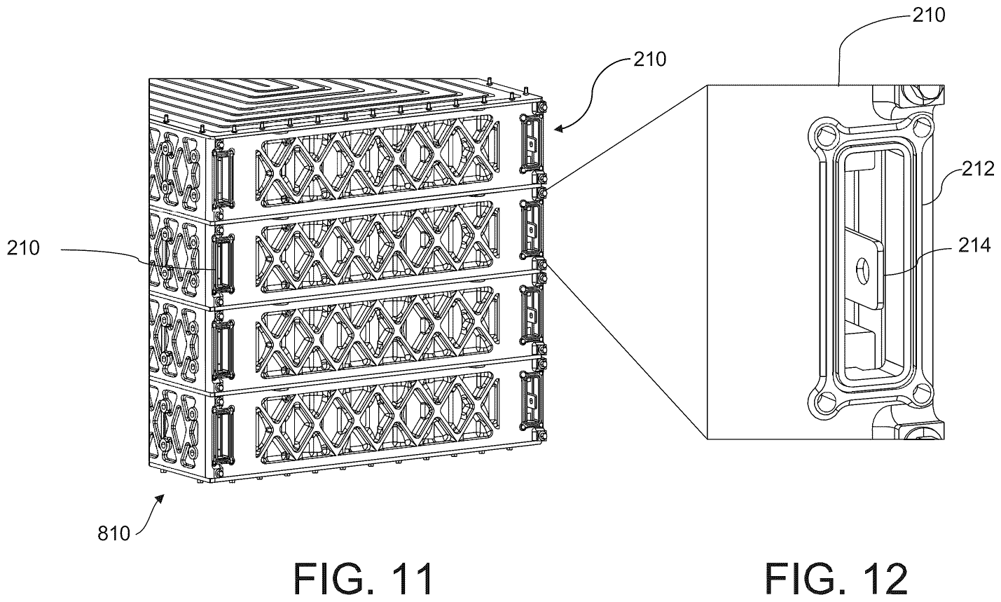

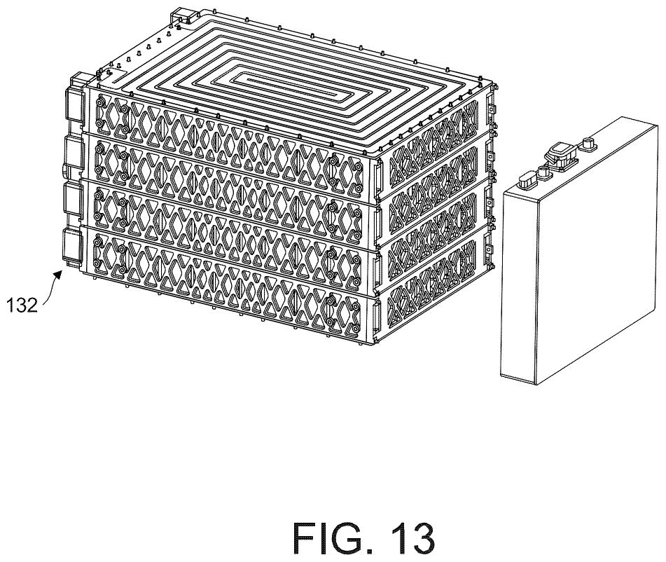

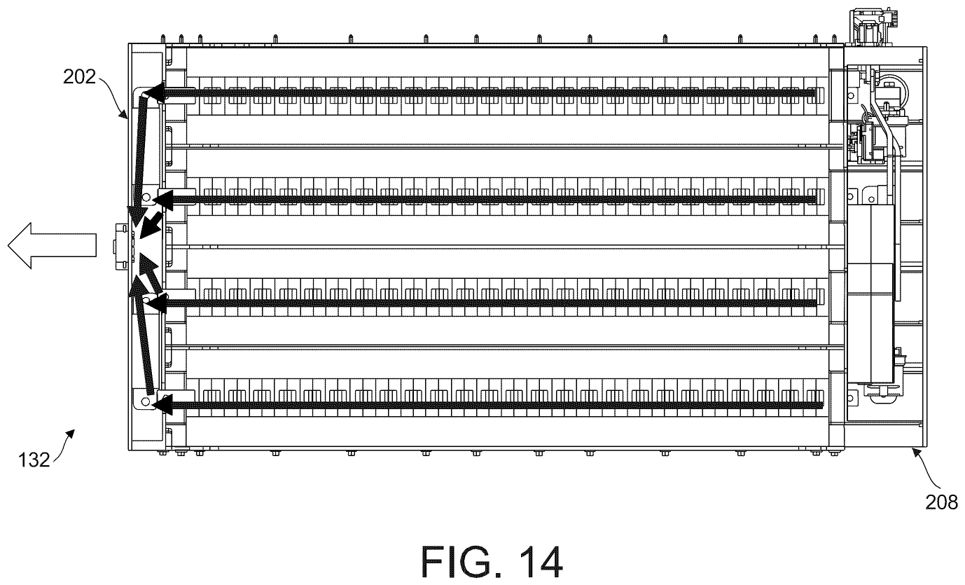

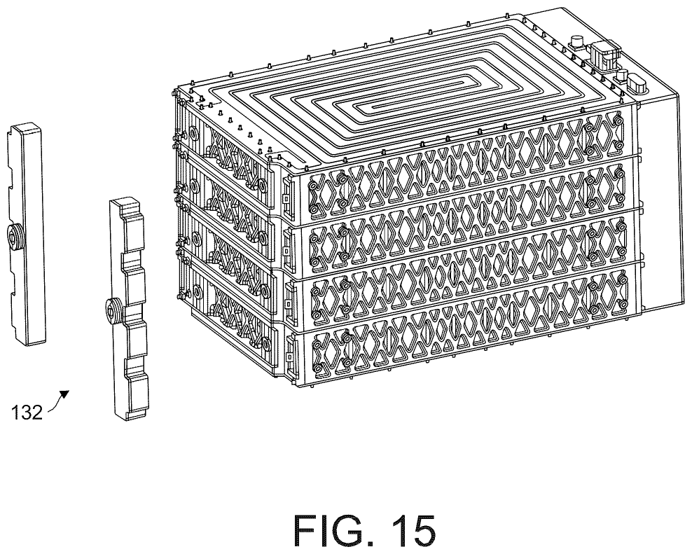

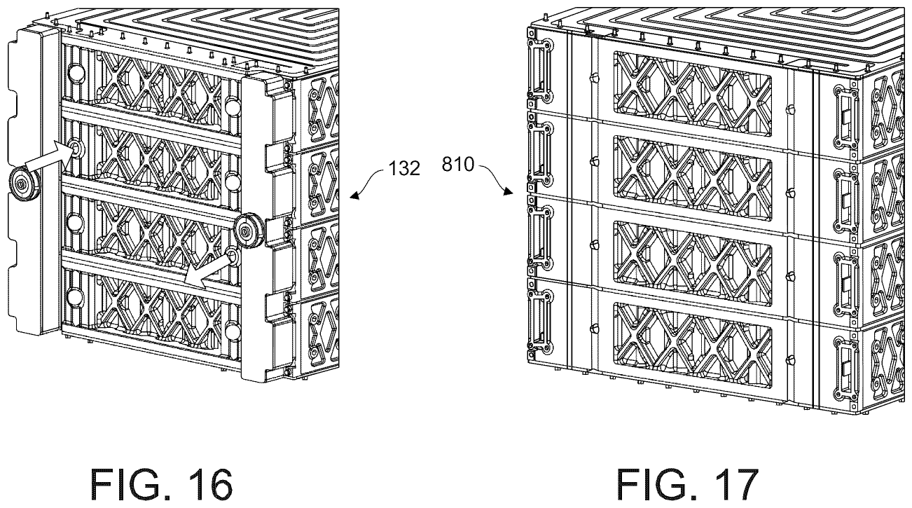

FIGS. 11-17 show various aspects of additional sections that are attachable to the middle section of the battery pack. FIG. 11-13 shows aspect of an E-Box 208. In particular, FIG. 11 shows a face of the middle section to which the E-Box 208 is attachable, FIG. 12 shows an interface in an endplate at which the E-Box 208 is placed in communication with cells 220 of a tier, and FIG. 13 shows an exploded view of a E-Box 208 before mating with the middle section. FIGS. 14 and 15 show aspects of vent gas collection features in an example battery pack and, in particular, FIG. 14 shows a vent gas path through the battery pack and exhaust via a manifold 202 attached to the middle section and FIG. 15 shows an exploded view of portions of the vent gas collection before attachment to the middle section. FIG. 16 shows vents stemming from vertical channels in an integrated coolant distribution manifold 202 formed at an endplate. Some vents (those without directional flow arrows) are plugged while other vents (with directional flow arrows) are unplugged. FIG. 17 shows a vertical cross section of the integrated coolant distribution manifold 202 to show innards of the vertical cooling channels. Notably, the endplate can be used on either or both sides of the middle section to attach to the E-Box 208 and manifold 202.

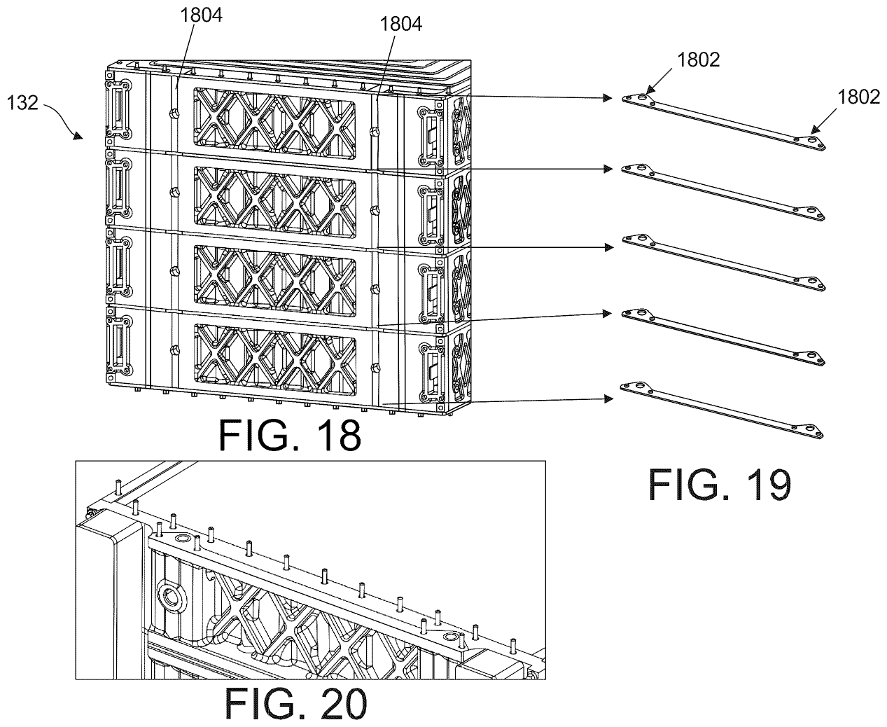

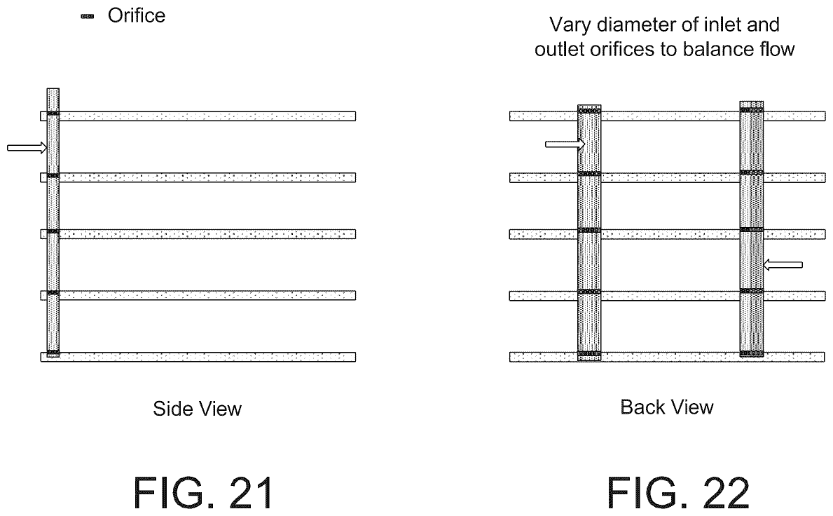

FIGS. 18-22 shows examples of how flow through the coolant distribution manifold 202 can be modified. In particular, FIG. 18 shows vertically oriented cooling channels that are formed into the endplate with cooling holes at each tier. FIG. 19 shows orifice plates 1802 that can modify flow through the cooling channels when assembled. FIG. 20 shows orifice plates 1802 positioned at cooling passages 1804 formed between the cooling channels in the endplate and the manifold 202. FIG. 21 shows a side schematic view of the cooling passages 1804 and orifices while FIG. 22 shows a back view of the schematic shown in FIG. 21.

As can be observed in FIGS. 2-22, the battery pack is a modular, cell-to-pack battery pack 132. For instance, the battery pack 132 can have multiple configurations, including various dimensions (e.g., height, length, width) and arrangements (e.g., one or more tiers and the like) depending on the application. In this regard, the battery pack 132 can be made to fit within numerous design envelopes and to meet various power demands. Different battery pack 132 configurations with identical battery construction (e.g., identical cell tier stacking) can be achieved by ranging from a single tier up to 10 tiers, for instance, though all levels of tiers are contemplated.

Multiple sections are included in the battery pack 132. To start, the battery pack 132 uses one or more of cells 220 with cell terminals on opposing distal ends. These cells 220 are included in a first section (or middle section) that further includes at least one (e.g., a plurality or all) of an open or closed frame structure, structural adhesives, electrical insulation materials, thermal interface material 222, high voltage current carriers, low voltage harness, and cooling plates 224. A second section (or front section) of the battery pack 132 at least one (e.g., a plurality or all) of an electrical box 208 containing electrical and controls components including battery pack 132 controller, cell supervisory circuits, contactors, fuses, high voltage and low voltage current carriers, contactors, connectors, MSD and other auxiliary components as required for the electrical circuit. And a third section (or a rear section) of the pack contains the thermal propagation venting devices and auxiliary coolant components. This is just an example of many examples disclosed herein. Also contemplated, for instance, are battery packs 132 with more or less sections, with a merger of these sections, a rearrangement of these sections, and the like.

Configurations of example battery packs 132 can include one or more of the following implementations: long cell-to-pack construction, multisided cooling of cells 220, an electronics box (or “E-Box 208”) separated from a cell section, a vent gas collection box separated from the cell section, an integrated coolant distribution manifold 202, identical cell tier stacking, and integrated orifice flow balance features. Like the aforementioned sections, also contemplated are battery packs 132 with any number of these implementations. Each of these implementations are discussed in further detail here below.

Regarding implementations where the long cell-to-pack construction, example battery packs 132 can be constructed into various form factors using cell stack tier and cell count variants. To start, the number of cells 220 in a battery pack can be arranged in series and easily adjusted per requirements. The battery pack 132 can be formed using tiers of cells 220. For instance, as a first variable, battery pack 132 variations allow for each tier to have varying numbers of cells 220 in series with a common architecture. Such a common or identical tiering strategy allows for varying number of pack tiers to be stacked, which can be a second variable. By manipulating one or both of these variables, many battery pack variants can be easily implemented while keeping common parts and processes. This process can result in battery packs 132 with four tiers and one unit length, three tiers and one unit length, two tiers and two unit lengths, two tiers and two unit length, and the like. Notably, each of the first three configurations shown can have the same voltage.

Regarding implementations where the multisided cooling of cells 220, example battery packs 132 include cooling on at least two sides of the cell. For instance, the battery pack can cool cells 220 on top and bottom. This feature allows for a limited and symmetric thermal gradient, enabling the cell to maintain a lower temperature over life. Also contemplated are examples where cooling occurs at more than two sides (e.g., top, bottom, and one or more sidewalls therebetween) and less than two sides in combination with the other implementations as desired applications. Notably, the cooling surfaces can be positioned along the largest surfaces of the cell so as to provide optimal cooling.

In another implementation, example battery pack 132 there is cooling at a single side of the cell. Such battery packs 132 can have cooling one of the top and bottom. Under these circumstances, there can be a cover on the top and only cool the bottom. This is just one example of many examples of having cooling on a single side.

Regarding implementations where the E-Box 208 is separated from a cell section, the E-Box 208 can be modularly attachable to the cells 220. For instance, the E-Box 208 is removably attachable to other sections of the battery pack, in communication with the cells 220. In this way, the E-Box 208 is easily attachable/detachable from the cell section through bolted joints. This enables parallel manufacturing and improved serviceability. In examples, each tier in the battery pack 132 can have one or more interfaces 210 configured to place the E-Box 208 in communication with at last the cells 220 in the respective tier. As depicted, the interface 210 includes a receptacle 212 and is optionally provided with a tongue 214 that is connected to a bus in communication with the cells 220. The tongue mates with a complementary interface at the E-Box 208, such as a protrusion that extends into the receptacle and receives the tongue. Other interfaces (e.g., at least those vice versa to those explained above) are possible and well within the scope of this disclosure.

Also contemplated are implementations where the E-Box 208 is combined with the cell section. For instance, there can be example battery packs 132 having a single tier battery for a very low-profile space. Under these circumstances, there may not be a separate box, but one that is integrated into the endplate.

Regarding implementations where a vent gas collection box is separated from the cell section, example battery packs 132 can be configured for high-performance venting. For instance, if a cell gets into a thermal event, the vent gasses only get exposed to the cells 220 on a single tier until reaching a cell gas collector in a manifold 202 near the rear of the pack. After collection, vented gases will vent out to atmosphere. As shown, the manifold 202 is separately attachable to the cell section on an opposite side from the E-Box 208. The manifold 202 attaches similarly to the E-Box 208 in that there are mating interfaces between the manifold 202 and one or more tiers in the cell section. This manifold 202 can also serve as a tier-to-tier busbar connection manifold 202. In this way, vent gas collectors are added to the pack to enable easy tier to tier high voltage connection and to collect vent gasses from each tier for venting to external environment. Venting can be pressure activated such that venting occurs when gas build s up to a certain pressure, which can be set to a value that corresponds to efficiency, safety, etc. as the case may vary.

Additionally, gas can be vented to the E-Box 208, and eliminate the collectors. In this case, there can be tier-to-tier electrical connection using an external jumper cable.

Regarding implementations with an integrated coolant distribution manifold 202, example battery packs 132 can be configured for high-performance cooling. Coolant can be distributed throughout all the tiers via a vertical passage. Under these circumstances, the vertical passage can be sealed by each cooling plate. One or more cooling plates 224 have an opening that allows flow to enter and exit after it has been distributed through the cooling plate. As can be seen at the cross section showing the flow distribution channels, in this example battery pack there are eight coolant ports in the rear of the pack due to common tier part numbers, two of which are used for inlet/outlet and the other six of which are plugged. More or less coolant ports can be plugged as desired for particular applications.

In other implementations, there can be a separate coolant distribution manifold 202. For instance, in application where an integrated cooling manifold 202 has a higher risk of leaks, the separate coolant distribution manifold 202 can be removably attached with optional sealing.

Regarding implementations with integrated orifice flow balance features, orifices can be integrated to modify flow between tiers. For instance, an orifice assembly can be added as shown between each layer. An orifice assembly is added between each layer and cooling plate. A diameter of the orifices can be varied to restrict flow where necessary to achieve equal flow split between tiers. This function can also be accomplished through varying the diameter of any component in the manifold 202, such as the endplate, cooling plate, etc.

In one general aspect, battery pack 132 may include a cell arrangement 226 including one or more cells 220. The cell arrangement 226 is configured to store energy for conversion into electrical energy for use in the energy storage system. The cell arrangement 226 includes at least one modular cell group 800. Battery pack may also include a thermal management system 228 having a plurality of cooling plates 224. The plurality of cooling plates 224 may includes first and second cooling plates 224. The first and second cooling plates 224 sandwich the one or more cells 220 in the cell arrangement 226. In examples, a first cooling plate is arranged at a first side of the cell arrangement 226 and a second cooling plate is arranged at a second side of the cell arrangement 226.

Battery pack 132 may furthermore include an open frame 230 with which to secure the cell arrangement 226 and the thermal management system 228, the open frame 230. The open frame 230 may include first and second endplates 206 flanking the cell arrangement 226. The first endplate 206 may be integrable into a manifold 202 for vent gas collection. In examples, this collection can occur at least in a direction from the second endplate to the first endplate 206. The second endplate may be integrable into an electrical box 208 that houses a majority of electrical components for the battery pack 132. The electrical box 208 includes circuitry for placing the cells 220 in electronic communication with a battery pack 132 controller (not shown). Other embodiments of this aspect include corresponding computer systems, apparatus, and computer programs recorded on one or more computer storage devices, each configured to perform the actions of the methods.

Implementations may include one or more of the following features. Battery pack 132 where the battery pack 132 has any number or each of the cell arrangement 226, the thermal management system 228, and the open frame 230. Battery pack 132 where a first modular cell group of the at least one modular cell group 800 may be configured to adjoin a second modular cell group of the at least one modular cell group 800 to form a stack. Battery pack 132 where the thermal management system 228 is isolated between tiers of the at least one modular cell group 800. Battery pack 132 may include an alignment feature where the one or more cells 220 is plurality of cells 220 aligned along a datum.

Battery pack 132 may be configurable into a variety form factors. The first modular cell group may be similar to the second modular cell group such that dimensions of the first and second modular cell groups constitute a unit measurement of the stack. battery pack 132 where the stack has a unit height of one and a unit length of at least two. battery pack 132 where the stack has a unit length of one and a unit height of at least two. battery pack 132 where the stack has a unit length of at least two and a unit height of at least two. battery pack 132 where the unit height is one and the unit length is one, and where the electrical box 208 is integral to the first endplate 206 and the manifold 202 is integral to the second endplate. Implementations of the described techniques may include hardware, a method or process, or a computer tangible medium.

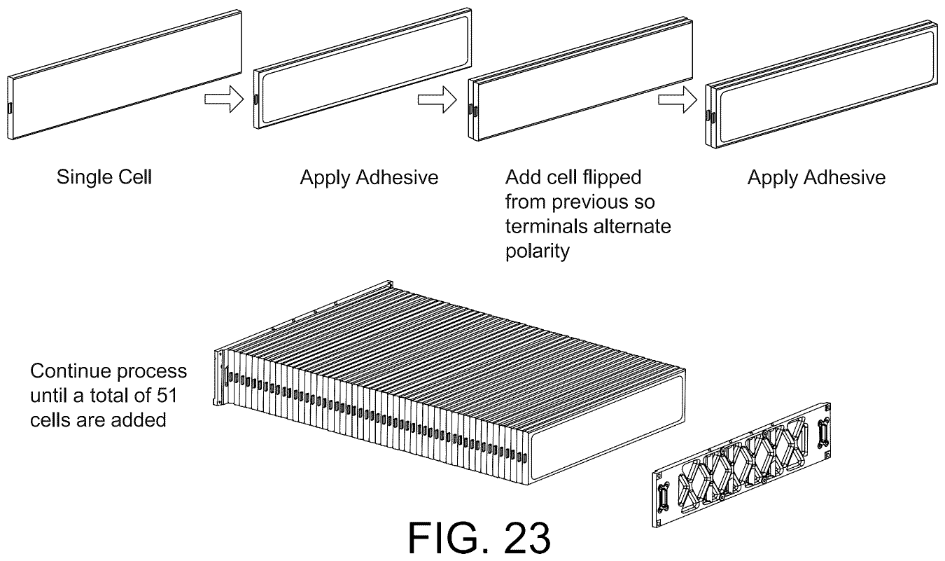

FIGS. 23-31 show an assembly sequence for battery packs 132 disclosed herein. This sequence occurs in multiple steps as illustrated across these figures.

FIG. 23 shows a process by which numerous cells 220 are adhered with alternating polarity for forming a tier of the battery pack. While shown having alternating polarity, other arrangements will be apparent to one skilled in the art. As shown, an adhesive is applied to a single cell (e.g., a first cell). Another cell (e.g., a second cell) is flipped relative to the first cell so that the polarities of the first cell are opposite to the polarities of the second cell. This creates a stack (or the beginnings of a larger stack) to which additional adhesives can be applied to add additional cells 220 to a desired amount. Illustrated is a stack of 51 cells 220.

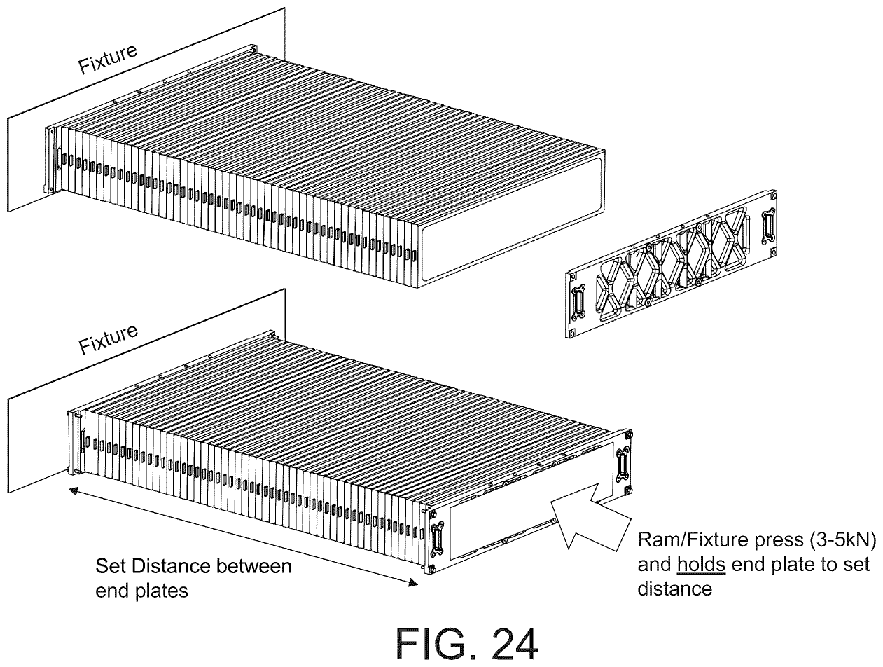

FIG. 24 shows a setup for a ram fixture to compress and hold endplates to a set distance. Illustrated here is a stack shown adjoining a fixture and two endplate, one arranged between the stack and the fixture at a first end and another at a second, opposite end of the stack. The endplate is shown to be pressed against the stack in a direction toward the fixture. This pressing can be a ram/fixture press that presses and holds the endplate to a fixed distance or set distance between two plates. This pressing can have a force of about 3-5 kN. While shown having force at one end, it is contemplated that compression can be applied at various locations, including at both ends.

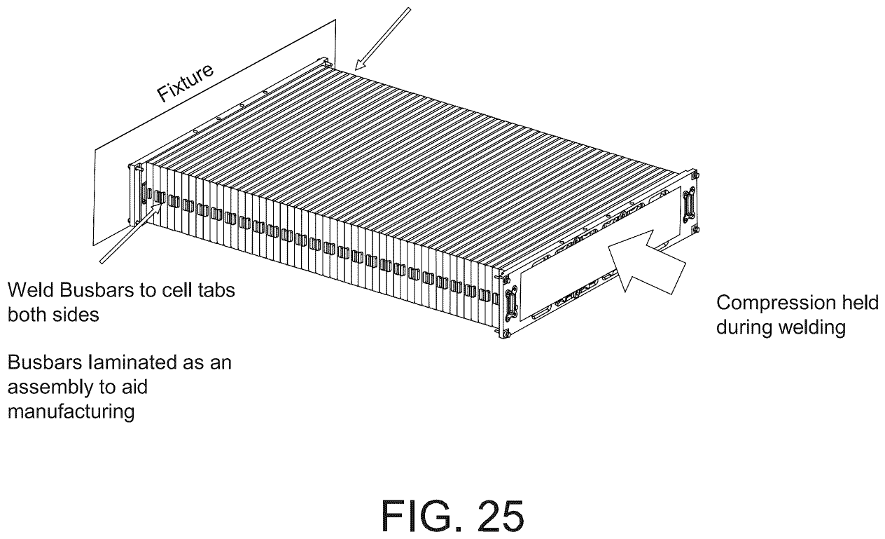

FIG. 25 shows a step of welding busbars to tabs of the cells 220 while compression is held and/or the cells 220 being laminated as an assembly. During welding, busbars are welded to cell tabs on both sides of the cell for numerous (e.g., all) cells 220 in the stack. This welding can be performed sequentially or simultaneously at both sides or at a single side of the stack in non-limiting examples. Busbars are laminated as an assembly to aid in manufacturing.

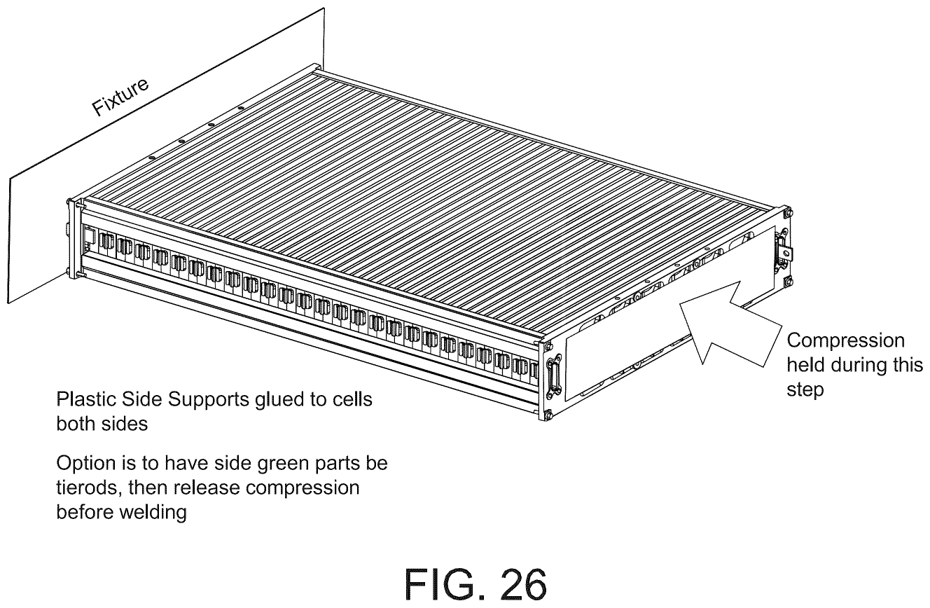

FIG. 26 shows a step at which supports are connected to the cells 220 and, optionally, have those structures be tie rods to allow compression to be released before welding. Rigid support guides (e.g., made from plastic, metal, or the like) act as supports for the stack. The supports are fastened (e.g., via adhesive or fasteners) to both sides of the stack. At this point, there is an option to have the rigid supports be tie rods. The rigid supports secure the endplates at the fixed distance. As such, compression can be held as the rigid supports are installed. Then the compression is released before welding commences.

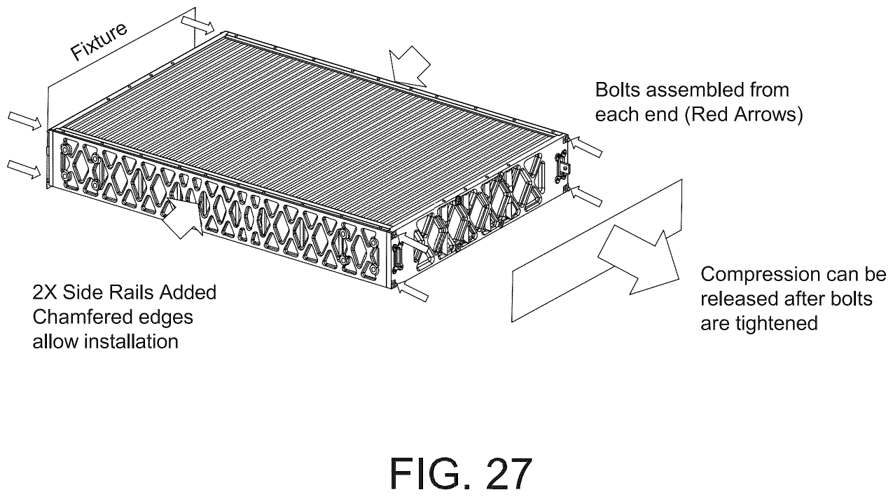

FIG. 27 shows a step at which side rails are attached (e.g., via fasteners) at which point the compression can be release. The side rails can be mechanically joined, for example either via fasteners (e.g., bolts) or welding to endplates. Illustrated here, the stack is flanked at the sides by two side rails. A feature or cutout can be added to the side rails to facilitate mating with the rigid supports. When using tie rods, for example, nuts can be fastened onto the bolt end or ends of the tie rod.

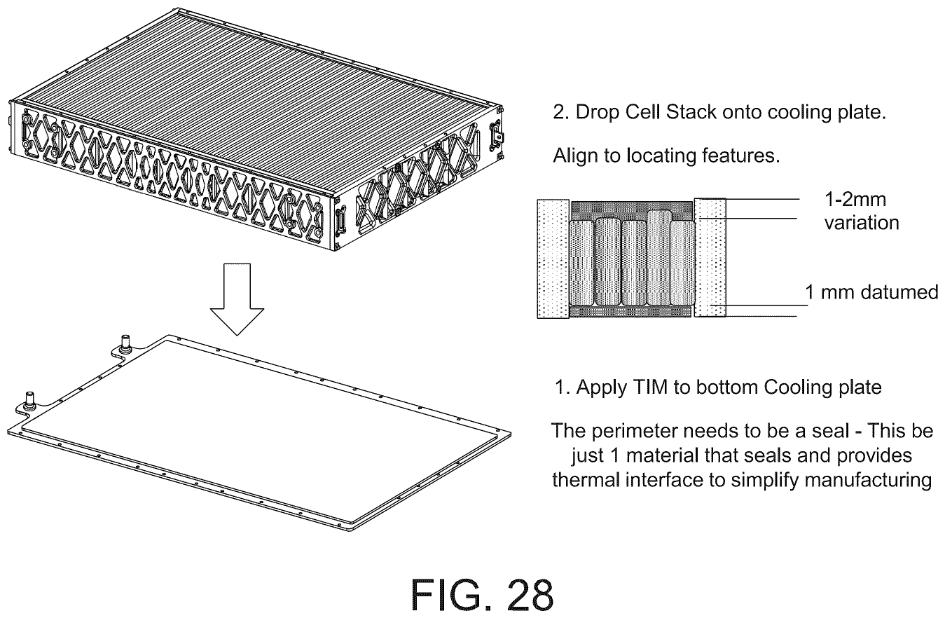

FIG. 28 shows a step at which a bottom of the cell stack is aligned on thermal interface material 222 (“TIM”) on a cooling plate, aided by locating features. To begin, TIM is applied to a bottom of the cooling plate. The perimeter is sealed. The seal can be formed from 1 material that seals and provides thermal interface to simplify manufacturing. Then the cell stack is placed onto the cooling plate. Placement is facilitated by locating features. As illustrated, the locating featured include a 1 mm datum that serves as a reference at one side and a 1-2 mm variation on the other side of the datum.

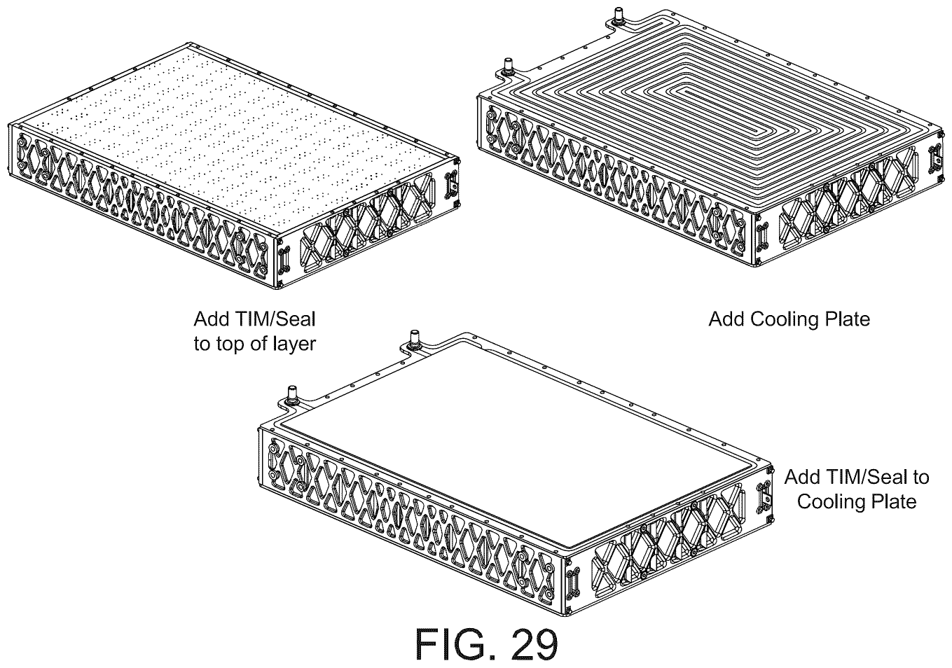

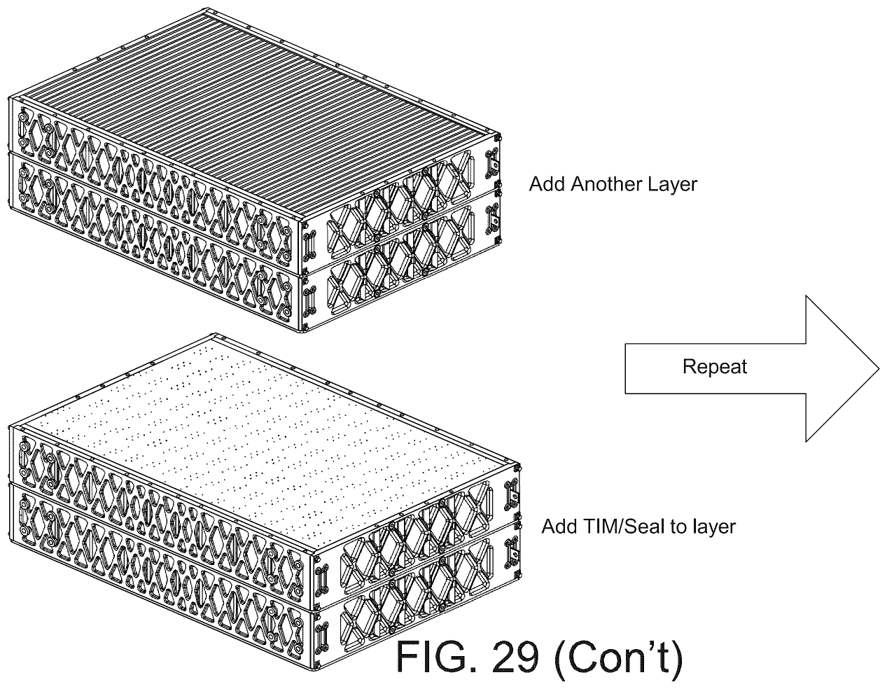

FIG. 29 shows a step at which tiers can be stacked if desires by adding TIM and/or sealant to a top surface of the cell stack followed by a cooling plate. TIM can be placed atop that cooling plate and the assembly process can be repeated to form multiple tiers or layers of the battery pack. To begin after completing the process discussed above in relation to FIG. 28, TIM/Seal 222 is added to top of a layer, which is formed by the combination of the stack and cooling plate. Atop the TIM/seal 222 on the layer, the cooling plate is added. This layering process can be repeated until the desired number of layers and/or desired height are achieved.

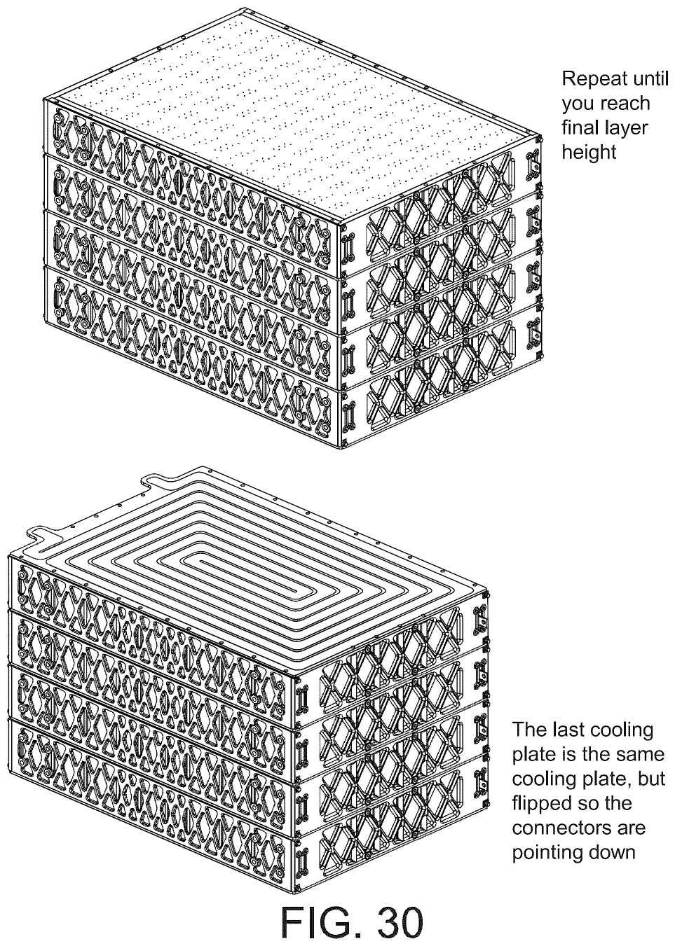

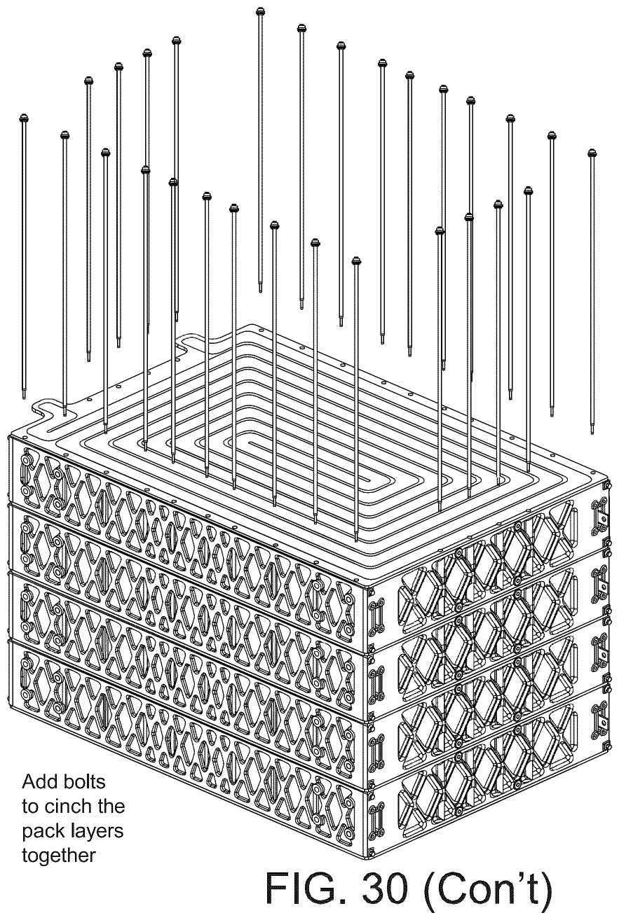

FIG. 30 shows a step at which the tiers are secured via bolts and/or welding. The last cooling plate is the same cooling plate, but flipped so the connectors are pointing down. Here, the final number of layers is shown without a cooling plate. In this regard, the last cooling plate can then be added. For simplicity, this cooling plate can be the same as other cooling plates 224 used in constructing the layers. Then bolts can be inserted vertically through the layers (e.g., about the periphery of layers) to cinch the layers together.

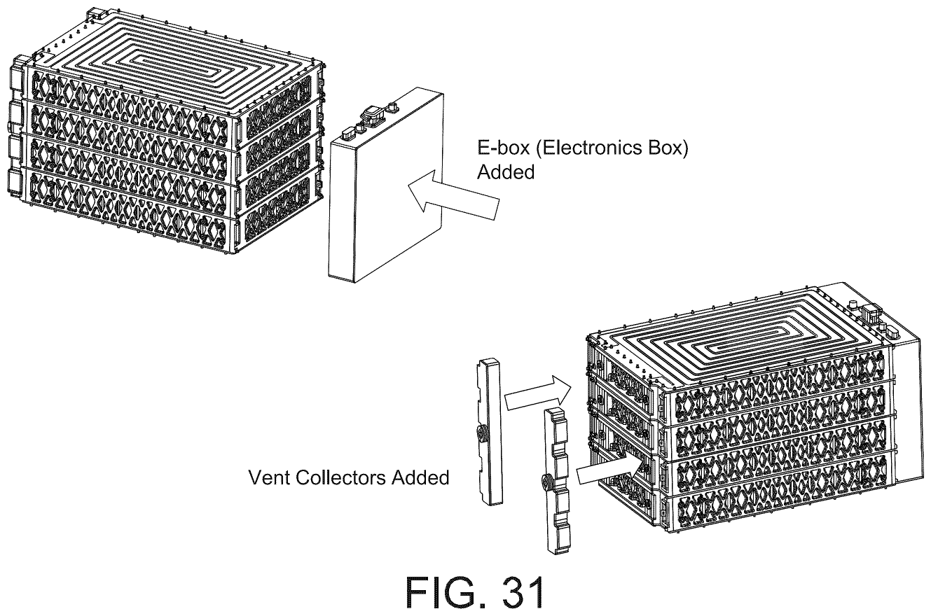

FIG. 31 shows a step at which the E-Box and vent collectors are added to flank a middle section of the battery pack. After cinching with the fasteners, the layers are secured such that external components can be attached to the layers. As shown in this figure, an E-box is added to an end (e.g., a first layered end) of the layered structure. And vent collectors are added to the opposite end (e.g., a second layered end) of the layered structure. The E-box and the vent collectors can be similar to those discussed elsewhere herein.

In one general aspect, method may include arranging a plurality of cells 220 into a cell arrangement 226 to form a stack. Method may also include capturing the cell arrangement 226 between an open frame 230 such that at least one of a top portion and a bottom portion of the stack are exposed to form an exposed portion. Method may furthermore include fitting a cooling plate at the exposed portion of the stack to form a modular cell group that includes the plurality of cells 220, the open frame 230, and the cooling plate. Other embodiments of this aspect include corresponding computer systems, apparatus, and computer programs recorded on one or more computer storage devices, each configured to perform the actions of the methods.

Implementations may include one or more of the following features. Method arranging the plurality of cells 220 into the cell arrangement 226 to form the stack includes alternating a polarity of adjacent cells 220 within the stack, and adjoining the adjacent cells 220. Method where the plurality of cells 220 consists of an odd number of cells 220. Method where the capturing the cell arrangement 226 between the open frame 230 such that at least one of the top portion and the bottom portion of the stack are exposed to form the exposed portion includes: supporting a first endplate 206 of the open frame 230, compressing the stack at a second endplate of the frame in a direction toward the first endplate 206 to a fixed distance between the first and second endplates 206; and attaching, while the stack is under compression, a side plate 204 to the first and second endplates 206 to keep the stack at the fixed distance. Method where the modular cell group is a first modular cell group, the method may include repeating the method to form a second modular cell group, and attaching the first and second modular cell groups together. Method where a unit length of the stack is greater than a unit width of the stack. Method where at least one of the unit length and the unit height is greater than two. Implementations of the described techniques may include hardware, a method or process, or a computer tangible medium.

In one general aspect, high-voltage power system may include. High-voltage power system may also include a cell-to-pack battery that is operatively connected to the circuitry, the cell-to-pack battery having: a cell arrangement 226 including one or more cells 220, the cell arrangement 226 configured to store energy for conversion into electrical energy for use in the high-voltage power system; a thermal management system 228 having at least one of a first cooling plate arranged at a first side of the cell arrangement 226 and a second cooling plate is arranged at a second side of the cell arrangement 226; and a modular open frame 230 with which to secure the cell arrangement 226 and the thermal management system 228, the modular open frame 230 including a manifold for vent gas collection and an electrical box 208 that houses a majority of electrical components for the battery pack, each of the manifold and the electrical box 208 being connectible to the cell arrangement 226. Other embodiments of this aspect include corresponding computer systems, apparatus, and computer programs recorded on one or more computer storage devices, each configured to perform the actions of the methods.

Implementations may include one or more of the following features. High-voltage power system where the high-voltage power system is integrated into a powertrain for an electrified vehicle. High-voltage power system where the powertrain is integrated into an electrified vehicle. High-voltage power system where the high-voltage power system is integrated into a stationary storage system. Implementations of the described techniques may include hardware, a method or process, or a computer tangible medium.

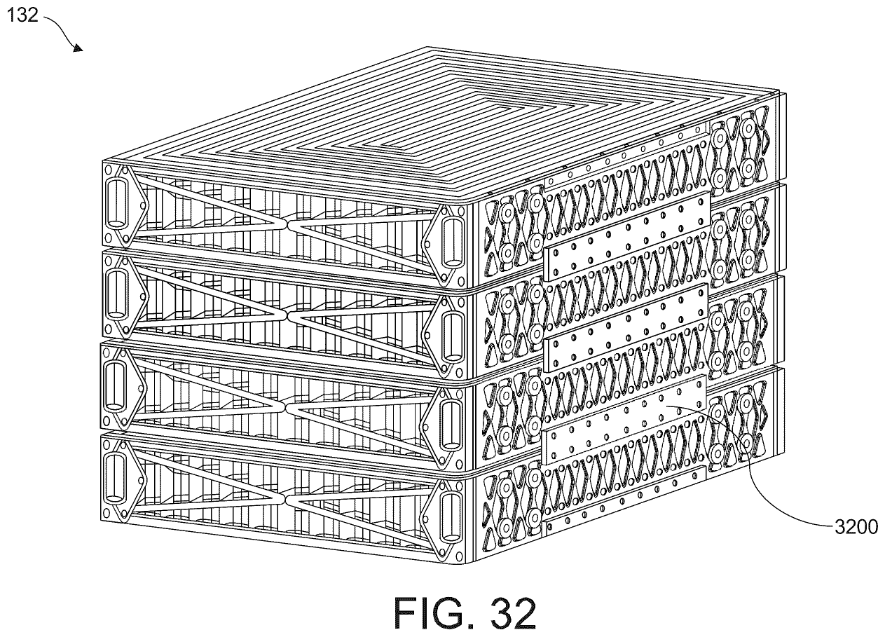

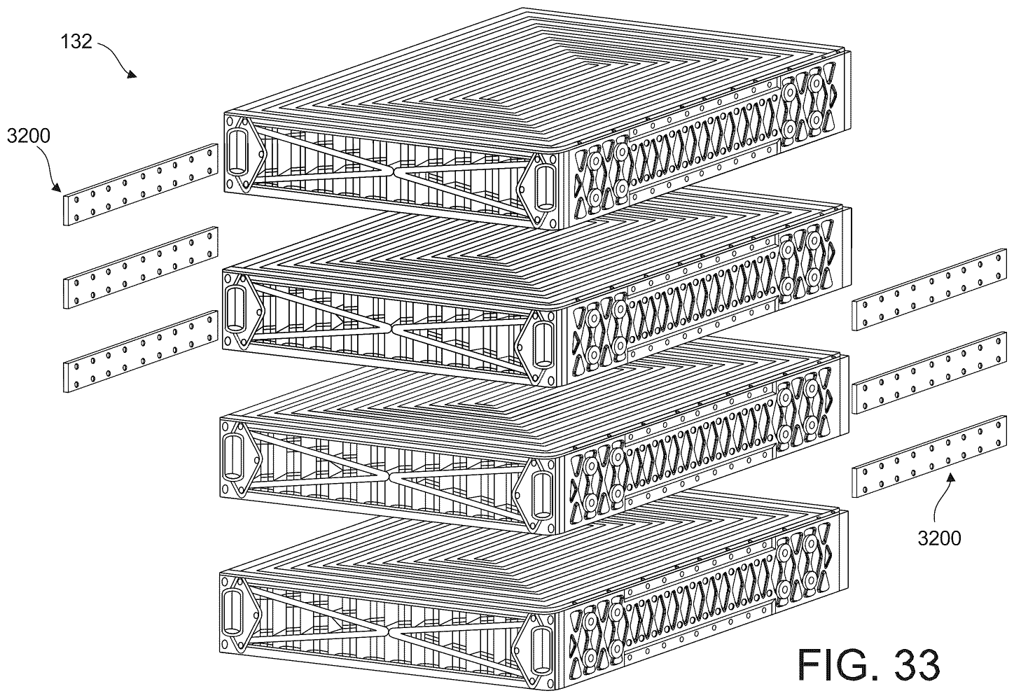

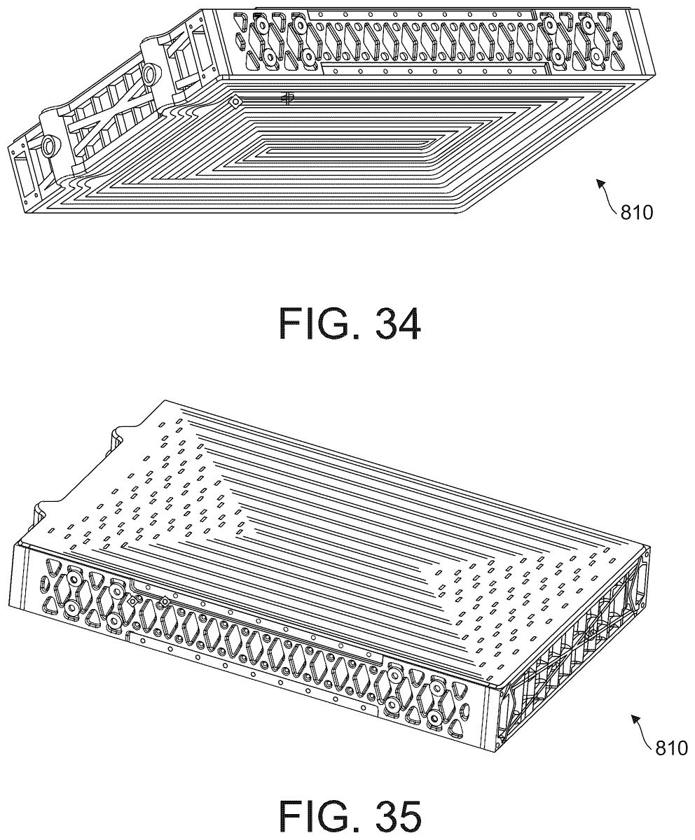

In addition, or in alternative, to the mechanical joining shown in FIGS. 30 and 31, the battery pack can have mechanical joining via welding or brazing for example. FIGS. 32-35 show examples of a battery pack that has welded tiers. FIG. 32 shows a stack of welded tiers while FIG. 33 is an exploded view of FIG. 33. FIG. 34 is a perspective view showing a bottom of a welded tier, and FIG. 35 is a perspective view showing a top of the welded tier in FIG. 34.

As illustrated, welding occurs where the cooling plates 224 meet the endplates and side plates (as illustrated by the orange lines). This type of welding can eliminate the need to separately seal the tiers as they will be permanently joined as opposed to removably joined. In addition, or in alternative, welding allows for at least two cooling plates 224 to be placed between tiers as each tier where each tier is permanently joined with two cooling plates 224 welded to the endplates 206 and side plates 204.

As noted above, the battery pack can have a modular construction between sections. Details about the construction of those sections will now be discussed. Manufacturing the middle section can be divided into 3 main processes. Process 1 includes a tier assembly process. Process 2 includes stacking multiple tiers (if required) and assembling the cooling plates 224. Process 3 includes clamping the tiers together as a single enclosure. After assembled, other sections can be attached to the middle section.

During process 1, tiers of the battery pack are assembled. This process leverages an open frame 230 approach, which leads to a simple and less complex design and manufacturing process. Such a process can include stacking all the cells 220 starting either from a rear or front structural member to build the pack tier/layer. Starting from the front or rear structural member, the tier assembly process includes adding consecutive layers of structural adhesives and cells 220 until the full battery pack tier assembly is completed. The number of cells 220 may vary depending on the pack application. Front or rear structural members can be positioned in place to sandwich combinations of cells 220 and adhesives (e.g., rear structural member, adhesive 1, cell 1, adhesive 2, cell 2, adhesive 3, cell N, adhesive N, front structural member). After the battery pack tier is assembled and secured in place by manufacturing jigs and fixtures either by applying or not applying a compression force to the pack tier, the high voltage current carriers and low voltage harness can be assembled to the Pack tier by using welded or bolted connections. After this step is completed, the lateral structural members (left and right) can be assembled to the pack tier by welded or bolted connection closing the tier and completing the enclosure assembly. At this point, manufacturing jigs and fixtures can be released.

During process 2, cooling plates 224 are fitted between cells 220 and/or tiers. The tiers are stacked in the pack to have cooling plates 224 in between the tiers in addition to the cooling plate at the bottom and top of the final tier stack. Sequential steps include positioning the bottom cooling plate, dispensing thermal interface material 222 and/or structural adhesive, first tier, dispensing thermal interface material 222 and/or structural adhesive, second tier, dispensing thermal interface material 222 and/or structural adhesive, Nth tier, dispensing thermal interface material 222 and/or structural adhesive, top cooling plate. Generally, there can be dispensing of TIM (which may be preferable due to good robotic assembly), and/or there can be a thermal interface pad (which is also used in battery packs but incurs handling penalty as it is difficult to get it aligned and laid down flat). Note that all cooling connections of the cooling plate are outside the tier enclosure. In case of any connection cooling leakage, the coolant leaks outside the pack enclosure and not inside which provides a more robust and safe pack.

During process 3, tiers are secured together either by bolted or welded connections. At the completion of this this process the middle section assembly is completed.

Overall, from this construction, it can be seen that an open frame 230 provides a simpler design and manufacturing process. This is due in part to the frame being used as part of the assembly and also as a tool to secure the cell stack. There is no need for a separate assembly line to build frames or cell stacks, or modules. The open frame 230 can consist of either die casting parts, extruded or stamped parts welded or bolted together as part of the manufacturing assembly process. The open frame 230 can also be pre-assembled as a closed frame. The rear structural member has the cooling manifold (used to connect the cooling plates 224 and manage the flow distribution through integrated orifices in between the tiers) integrated to it combining structural, cooling and sealing functions. This reduces the number of components required while improving packaging and cost. This is a competitive advantage. While delivering a high performance TMS, this design approach also preserves the simplicity of bottom cooling approach delivering a simple, robust and cost-effective design. The multi-tier middle section with cooling plates 224 at the bottom and at the top of the tiers (cell is cooled on both sides) delivers a high-performance TMS. This feature maximizes thermal performance of the cells 220 (cooling mode and heating mode), providing better performance and extended life for the cells 220 and battery pack.

Manufacturing the front section of the pack (e.g., the E-Box) can be done as a sub-assembly and/or in parallel with manufacturing the middle section. Parallel manufacturing minimizes overall manufacturing time while reducing manufacturing footprint and capital investment required. The E-Box assembly consists of placing and fixing all electrical and control components inside including components including battery pack controller, cell supervisory circuits, contactors, fuses, high voltage and low voltage current carriers, contactors, connectors, Manual Service Disconnect (“MSD”) and other auxiliary components as required for the electrical circuit. The E-Box can be manufactures out of a die casting of stamped and welded components. The E-Box has the benefit of flexible location for the high voltage and low voltage connectors and MSD, which improves the vehicle integration providing more flexibility for the OEMS. The E-Box also improves the overall serviceability of the Pack as all serviceable components are assessable through the E-Box with also the possibility of removing the entire E-Box and service the components outside the vehicle.

Final assembly of the Battery Pack includes the middle section with the E-Box and assembling the venting collector devices on the rear of the pack. This completes the assemble process. The multi-tier pack provides a safer pack with better thermal propagation behavior by having the tiers isolated from each other. In case of a cell venting, all the venting gasses are directed through the sides of pack into the venting collector on the rear of the pack without interacting with the cells 220 in the other tiers. This offers additional protection by preventing thermal propagation from one tier to another.

Various functions and methods disclosed herein can be performed by a processor executing instructions that are stored on a computer-readable medium. For instance, a non-transitory computer-readable medium storing a set of instructions for assembling a cell-to-pack battery pack. The battery pack can be similar to those discussed herein, including those discussed in relation to FIGS. 1-31.

Without reference to any particular figure, it is acknowledged that different external enclosures or casings for battery packs can be useful and customizable to different applications. For instance, such casings can be ruggedized and easily manufactured while improving shock, vibration, low temperature performance, accommodation of cell swelling, cost effectiveness, and the like. On the other hand, a battery pack employing principles of the present disclosure can include encapsulated battery cells without any additional external enclosure. In such an embodiment, an encapsulant can form at least a portion of the exterior surface of the battery pack. Further, disclosed are examples in which the encapsulant fully encapsulates the battery cells (e.g., with the electrode leads of the cells extending through the encapsulant are also described). Further still, examples in which the battery cells are at least partially encapsulated and are located within a rigid outer housing are also detailed herein. This housing in some examples can be filled with encapsulant. While any appropriate material may be used as an encapsulant, appropriate encapsulants include but are not limited to elastomers (e.g., silicones), epoxies, and/or any other appropriate material. In one specific embodiment, an encapsulant is a flexible polyurethane/polyurea blend. And in any of these instances where the battery cells are encapsulated, the display can be integrated into the encapsulation. Contemplated, however, are embodiments where the display is freestanding.

The examples described herein may refer to cell module assemblies and/or battery packs. However, it should be understood that these terms may be used interchangeably in the various examples to refer to a grouping of one or more electrically interconnected electrochemical cells.

As used herein, terms electrochemical cells, cells, and similar terms are meant to refer to individual battery cells such as coin cells, prismatic cells of various shape, jelly roll cells, pouch cells, or any other appropriate electrochemical device capable of acting as a battery. Additionally, a pouch cell, electrochemical pouch cell, and other similar terms are meant to refer to cells that include a deformable outer layer that typically includes layers of laminated polymers and metal foils surrounding an internal electrode stack or roll. Typically, pouch cells include larger flat opposing front and back surfaces and smaller side surfaces. Further, when forming stacks of pouch cells, the flat surfaces are typically stacked one on top of the other. However, certain examples may use multiple adjacent cell stacks where the cells are either in series and/or in parallel. In certain embodiments, other ways of arranging the cells may also be employed.

Non-limiting examples of various battery pack configurations and arrangements noted above include battery pack with a battery management unit and/or other associated electronics that provide various types of desired functionality. For instance, such battery packs include a plurality of battery modules electrically connected in series and/or parallel to achieve the target pack voltage. A battery management system monitors the voltage and current and manages overall operation of the battery pack. Each battery module comprises a plurality of battery cells electrically connected in series and/or parallel. Each battery module includes a battery management unit which monitors and manages charge and discharge of the cells in that module.

Although not illustrated or discussed exhaustively herein, one skilled in the art will appreciate that each battery management unit can include various sensors for facilitating serviceability and usability functions discussed elsewhere herein. For instance, voltage sensors can sense the voltages of individual cells or groups of cells. Each battery management unit may also include one or more temperature and/or pressure sensors which sense the temperature and/or pressure of the module and/or individual cells or groups of cells. The battery management system communicates with the battery management unit in each of the modules to monitor and manage overall operation of the battery pack. The battery management system and each of the battery management units include a processor with the appropriate software, along with memory and other components, which are used to monitor and manage charge and discharge. For example, in certain examples, a battery management unit may include circuitry that expands the number of cells for which the battery management unit may perform cell voltage sensing and balancing. In certain examples, the battery management unit may include overvoltage protection monitoring and interlock functionality. Additionally, a battery management unit may include circuitry and/or be programmed to implement a method of active and standby power supply adaption that provides lower active power dissipation. A battery management unit may also include external Flash Memory for more secure program bootloading. Of course, in certain examples battery management units may include combinations of the above noted functionalities and/or different functionalities.

It is well understood that methods that include one or more steps, the order listed is not a limitation of the claim unless there are explicit or implicit statements to the contrary in the specification or claim itself. It is also well settled that the illustrated methods are just some examples of many examples disclosed, and certain steps can be added or omitted without departing from the scope of this disclosure. Such steps can include incorporating devices, systems, or methods or components thereof as well as what is well understood, routine, and conventional in the art.

The connecting lines shown in the various figures contained herein are intended to represent exemplary functional relationships and/or physical couplings between the various elements. It should be noted that many alternative or additional functional relationships or physical connections can be present in a practical system. However, the benefits, advantages, solutions to problems, and any elements that can cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone can be present in an embodiment, B alone can be present in an embodiment, C alone can be present in an embodiment, or that any combination of the elements A, B or C can be present in a single embodiment; for example, A and B, A and C, B and C, or A and B and C.

In the detailed description herein, references to “one embodiment,” “an embodiment,” “an example embodiment,” etc., indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus.

While various embodiments of the disclosure have been shown and described, it is understood that these embodiments are not limited thereto. The embodiments may be changed, modified and further applied by those skilled in the art. Therefore, these embodiments are not limited to the detail shown and described previously, but also include all such changes and modifications.

What is claimed is:

1. A battery pack with cell-to-pack construction for integration into an energy storage system, the battery pack comprising at least two of:
a cell arrangement including one or more cells, the cell arrangement configured to store energy for conversion into electrical energy for use in the energy storage system, the cell arrangement including at least one modular cell group;
a thermal management system having a plurality of cooling plates that includes first and second cooling plates, the first and second cooling plates sandwich the one or more cells in the cell arrangement such that a first cooling plate is arranged at a first side of the cell arrangement and a second cooling plate is arranged at a second side of the cell arrangement; and
an open frame with which to secure the cell arrangement and the thermal management system, the open frame including first and second endplates flanking the cell arrangement, the first endplate being integrable into a manifold for vent gas collection at least in a direction from the second endplate to the first endplate, the second endplate being integrable into an electrical box that houses a majority of electrical components for the battery pack, the electrical box includes circuitry for placing the cells in electronic communication with a battery pack controller.

2. The battery pack of claim 1, wherein the battery pack comprising each of the cell arrangement, the thermal management system, and the open frame.

3. The battery pack of claim 1, wherein a first modular cell group of the at least one modular cell group is configured to adjoin a second modular cell group of the at least one modular cell group to form a stack, the first modular cell group being similar to the second modular cell group such that dimensions of the first and second modular cell groups constitute a unit measurement of the stack.

4. The battery pack of claim 3, wherein the stack has a unit height of one and a unit length of at least two.

5. The battery pack of claim 3, wherein the stack has a unit length of one and a unit height of at least two.

6. The battery pack of claim 3, wherein the stack has a unit length of at least two and a unit height of at least two.

7. The battery pack of claim 3, wherein the unit height is one and the unit length is one, and wherein the electrical box is integral to the first endplate and the manifold is integral to the second endplate.

8. The battery pack of claim 1, wherein the thermal management system is isolated between tiers of the at least one modular cell group.

9. The battery pack of claim 1, further comprising an alignment feature wherein the one or more cells is plurality of cells aligned along a datum.

10. A method of assembling a battery pack to have a cell-to-pack construction, the method comprising:
arranging a plurality of cells into a cell arrangement to form a stack;
capturing the cell arrangement between an open frame such that at least one of a top portion and a bottom portion of the stack are exposed to form an exposed portion; and
fitting a cooling plate at the exposed portion of the stack to form a modular cell group that includes the plurality of cells, the open frame, and the cooling plate.

11. The method of claim 10, arranging the plurality of cells into the cell arrangement to form the stack includes alternating a polarity of adjacent cells within the stack, and adjoining the adjacent cells.

12. The method of claim 11, wherein the plurality of cells consists of an odd number of cells.

13. The method of claim 10, wherein the capturing the cell arrangement between the open frame such that at least one of the top portion and the bottom portion of the stack are exposed to form the exposed portion includes:
supporting a first endplate of the open frame,
compressing the stack at a second endplate of the frame in a direction toward the first endplate to a fixed distance between the first and second endplates; and
attaching, while the stack is under compression, a side plate to the first and second endplates to keep the stack at the fixed distance.

14. The method of claim 13, wherein the modular cell group is a first modular cell group, the method further comprising repeating the method to form a second modular cell group, and attaching the first and second modular cell groups together.

15. The method of claim 14, wherein a unit length of the stack is greater than a unit width of the stack.

16. The method of claim 14, wherein at least one of the unit length and the unit height is greater than two.

17. A high-voltage power system, comprising:
circuitry and
a cell-to-pack battery that is operatively connected to the circuitry, the cell-to-pack battery comprising:
a cell arrangement including one or more cells, the cell arrangement configured to store energy for conversion into electrical energy for use in the high-voltage power system;
a thermal management system having at least one of a first cooling plate arranged at a first side of the cell arrangement and a second cooling plate is arranged at a second side of the cell arrangement; and
a modular open frame with which to secure the cell arrangement and the thermal management system, the modular open frame including a manifold for vent gas collection and an electrical box that houses a majority of electrical components for the battery pack, each of the manifold and the electrical box being connectible to the cell arrangement.

18. The high-voltage power system of claim 17, wherein the high-voltage power system is integrated into a powertrain for an electrified vehicle.

19. The high-voltage power system of claim 18, wherein the powertrain is integrated into an electrified vehicle.

20. The high-voltage power system of claim 17, wherein the high-voltage power system is integrated into a stationary storage system.
